(19) United States
(12) Patent Application Publication
(10) Pub. No.: US 2024/0246693 A1
(43) Pub. Date: Jul. 25, 2024

(54) FUEL COOLING SYSTEM

(71) Applicant: General Electric Company, Schenectady, NY (US)

(72) Inventors: Brian Magann Rush, Niskayuna, NY (US); Constantinos Minas, Slingerlands, NY (US); William Morton, Schenectady, NY (US)

(21) Appl. No.: 18/156,522

(22) Filed: Jan. 19, 2023

(51) Int. Cl. B64D 37/34; F02C 7/16; F02C 7/22

(52) U.S. Cl. CPC B64D 37/34; F02C 7/16; F02C 7/22; F05D 2260/213

(57) ABSTRACT

A fuel system includes a fuel tank that stores fuel therein, and a fuel cooling system. The fuel cooling system includes a fuel cooling system fuel line in fluid communication with the fuel tank, one or more fuel cooling system heat exchangers in fluid communication with the fuel cooling system fuel line, and a fuel cooling system fuel pump. The fuel cooling system fuel pump pumps the fuel from the fuel tank such that the fuel flows through the fuel cooling system fuel line and into the one or more fuel cooling system heat exchangers to absorb heat from one or more aircraft components to become heated fuel. The heated fuel is returned and stored in the fuel tank.

### TECHNICAL FIELD

The present disclosure relates generally to fuel cooling systems for vehicles, such as aircraft.

### BACKGROUND

Vehicles, such as aircraft, typically include a fuel system with one or more fuel tanks for supplying fuel to engines, such as turbine engines, of the vehicle.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1A is a top view of an aircraft having a fuel storage system, according to the present disclosure.

FIG. 1B is a port side elevational view of the aircraft of FIG. 1A, according to the present disclosure.

FIG. 2 is a schematic cross-sectional diagram of a turbine engine, taken along a longitudinal centerline axis of the turbine engine, according to the present disclosure.

FIG. 3 is a schematic flow diagram of a fuel system with a fuel cooling system for the aircraft as shown in FIGS. 1A and 1B, according to the present disclosure.

FIG. 4 is a schematic flow diagram of a fuel system with a fuel cooling system for an aircraft, according to another embodiment.

FIG. 5 is a schematic flow diagram of a fuel system with a fuel cooling system for an aircraft, according to another embodiment.

FIG. 6 is a schematic flow diagram of a fuel system with a fuel cooling system for an aircraft, according to another embodiment.

FIG. 7 is a schematic flow diagram of a fuel system with a fuel cooling system for an aircraft, according to another embodiment.

FIG. 8 is a schematic view of a fuel cooling control system for operation and control of at least portions of the aircraft as shown FIGS. 1A and 1B, according to the present disclosure.

FIG. 9 is a flow diagram of a method of cooling one or more aircraft components, according to the present disclosure.

### DETAILED DESCRIPTION

Additional features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” and “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine nozzle or exhaust.

As used herein, the terms “low” and “high,” or their respective comparative degrees (e.g., “lower” and “higher”, where applicable), when used with compressor, turbine, shaft, fan, turbine engine components, or aircraft components, each refers to relative pressures, relative speeds, relative temperatures, and/or relative power outputs within an engine unless otherwise specified. For example, a “low temperature” refers to a temperature that is lower than a “high temperature.” The terms “low,” or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine or of the aircraft.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, “turn on” or “turning on” a fuel cooling system includes controlling a fuel cooling system fuel pump, or a valve, to pump, or to otherwise direct, fuel from a fuel tank and into a fuel cooling system fuel line. For example, when the fuel cooling system is turned on, the fuel circulates through the fuel cooling system fuel line, absorbs heat through one or more fuel cooling system heat exchangers to become heated fuel, and the heated fuel is directed back into the fuel tank to be stored in the fuel tank.

As used herein, “turn off” or “turning off” a fuel cooling system, includes controlling the fuel cooling system fuel pump to prevent the fuel from being pumped out of the fuel tank and into the fuel cooling system fuel line. For example, the fuel is not circulated through the fuel cooling system when the fuel cooling system is turned off, and the fuel in the fuel tank is not heated by the fuel cooling system.

Aircraft include one or more fuel tanks that store fuel and a fuel delivery system that delivers the fuel from the one or more fuel tanks to a combustion section of an engine of the aircraft. The aircraft can include one or more thermal management systems for cooling one or more aircraft components, such as, for example, one or more systems of the aircraft and/or one or more turbine engine components. Such thermal management systems typically include one or more heat exchangers for absorbing heat from the one or more aircraft components. For example, the one or more heat exchangers can include an air-cooled heat exchanger and/or fuel-cooled heat exchangers. The fuel-cooled heat exchangers are typically coupled to the fuel tank for providing fuel from the fuel tank to the fuel-cooled heat exchangers as the fuel flows through a fuel delivery line to a combustion section of the engines. Such thermal management systems, however, may require large, air-cooled heat exchangers to provide adequate cooling for the aircraft components, which can adversely affect the total weight of the aircraft and/or the engines, an efficiency of the aircraft and/or the engines, and/or the complexity of the aircraft and/or the engines, and may present design challenges fitting the heat exchangers in particular compartments, or the like. Accordingly, the present disclosure provides for a fuel cooling system that includes a separate fuel line than the fuel delivery line to the combustion section so that the fuel can be used for supplemental heat capacity.

The fuel cooling system of the present disclosure uses the heat capacity of the fuel in the fuel tank, which is otherwise unused for thermal purposes, to absorb heat, particularly at peak demand conditions (e.g., during takeoff and climb of the aircraft), from separate subsystems in the aircraft. The subsystems can include, for example, a compressor cooling air (CCA) system, an environmental control system (ECS), electronics of the aircraft and/or of the engines, motors/generators, cooling burn fuel, or any other subsystem that heat up and requires cooling.

The fuel cooling system of the present disclosure reduces the problem of overdesigned thermal management systems due to high thermal loading during takeoff relative to the thermal loading at cruise. For example, the fuel cooling system includes transient thermal management controls to supplement the thermal management controls on the subsystems. The fuel cooling system is turned off upon reaching cruise conditions. In this way, the fuel cooling system provides additional cooling to the thermal management system separate from the existing heat exchangers. Accordingly, the fuel cooling system provides for decreasing the overall size and the overall weight of the thermal management system heat exchangers. For example, the large air-cooled heat exchanger (e.g., about 100 kW) of the existing thermal management systems can be replaced with a small air-cooled heat exchanger (e.g., about 10 kW) and a fuel-cooled heat exchanger that has a lower combined weight than the large air-cooled heat exchanger.

In some embodiments, the fuel tank can include a fuel tank heat rejection system that rejects the heat from the heated fuel that is stored in the fuel tank from the fuel cooling system. The fuel cooling system absorbs heat from the subsystems using the fuel as the working heat transfer fluid, and the heated fuel is returned to the fuel tank to be stored in the fuel tank. The fuel cooling system circulates the fuel from the fuel tank separately from the fuel delivery line such that the fuel cooling system can be independently controlled on and off, as compared to existing systems that continuously cool as the fuel is delivered towards the combustion section. The controls for routing the fuel may be passive or active. For example, passive control systems include cooling systems that are always on, and active control systems include cooling systems that are actively controlled, for example, by a controller. The fuel cooling system of the present disclosure can include an active control system for turning on the fuel cooling system when cooling is needed the most (e.g., during takeoff and climb of the aircraft), and for turning off the fuel cooling system when cooling is not needed (e.g., during cruise of the aircraft) or when the temperature of the fuel exceeds a maximum allowable temperature value (e.g., a predetermined high temperature threshold).

Further, the supplemental cooling from the fuel cooling system is not subject to the typical air-cooled or fuel-cooled heat exchanger performance limitations due to lower aircraft speeds or lower engine speeds. For example, the amount, or the mass flow rate, of the fuel in the fuel delivery line that is used to cool in existing thermal management systems is reduced during lower aircraft speeds or lower engine speeds because not as much fuel is being delivered to the combustion section for combustion during such conditions. The fuel cooling system of the present disclosure, however, can be actively controlled to provide fuel from the fuel tank to the thermal management system even at the lower aircraft speeds or lower engine speeds.

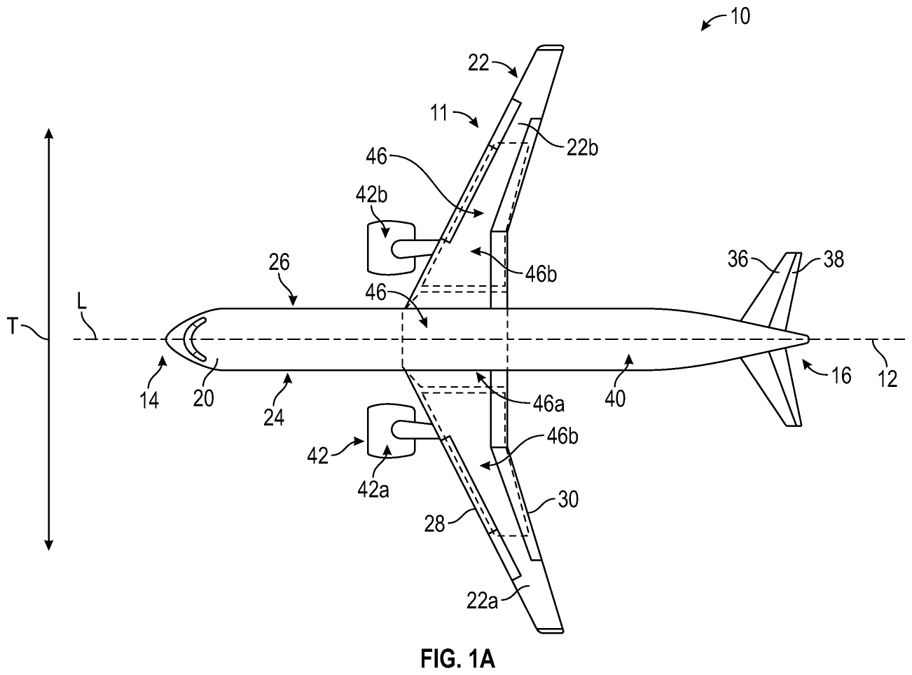

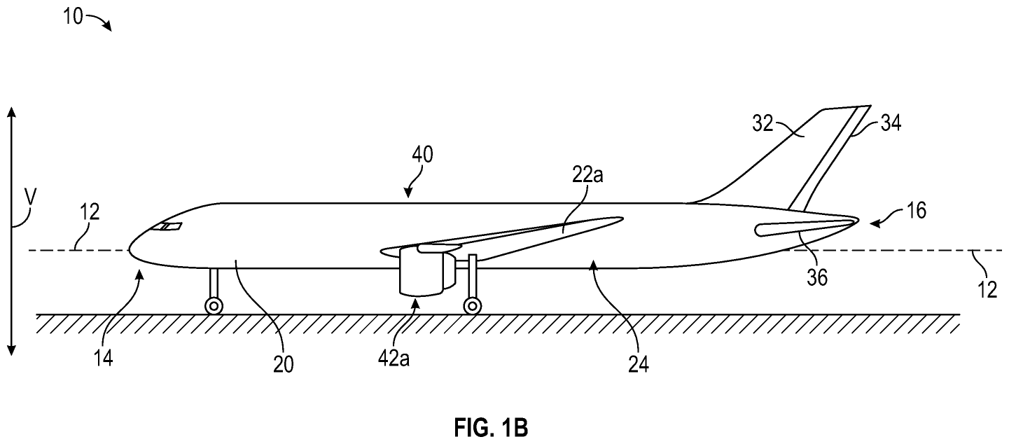

Referring now to the drawings, FIG. 1A is a top view of an aircraft 10 having a fuel storage system 11, according to the present disclosure. FIG. 1B is a port side 24 elevational view of the aircraft 10, according to the present disclosure. As shown in FIGS. 1A and 1B collectively, the aircraft 10 defines a longitudinal direction L that extends therethrough (extending parallel to a longitudinal centerline axis 12 provided for reference), a vertical direction V, a transverse direction T, a forward end 14, and an aft end 16.

The aircraft 10 includes a fuselage 20, extending longitudinally from the forward end 14 of the aircraft 10 towards the aft end 16 of the aircraft 10, and a plurality of wings 22 including a first wing 22a and a second wing 22b. The first wing 22a extends outwardly from the fuselage 20 generally along the transverse direction T with respect to the longitudinal direction L, from the port side 24 of the fuselage 20. Further, the second wing 22b similarly extends outwardly from the fuselage 20, generally along the transverse direction T with respect to the longitudinal direction L, from a starboard side 26 of the fuselage 20. Each of the plurality of wings 22 includes one or more leading edge flaps 28 and one or more trailing edge flaps 30.

Referring still to FIGS. 1A and 1B, the aircraft 10 further includes a vertical stabilizer 32 having a rudder flap 34 for yaw control, and a pair of horizontal stabilizers 36, each having an elevator flap 38 for pitch control. The fuselage 20 additionally includes an outer surface 40. However, in other exemplary embodiments of the present disclosure, the aircraft 10 may additionally or alternatively include any other suitable configuration of stabilizers that may or may not extend directly along the vertical direction V or horizontal/transverse direction T. Additionally, alternative stabilizers may be any suitable shape, size, configuration, or orientation while remaining within the scope of the present disclosure.

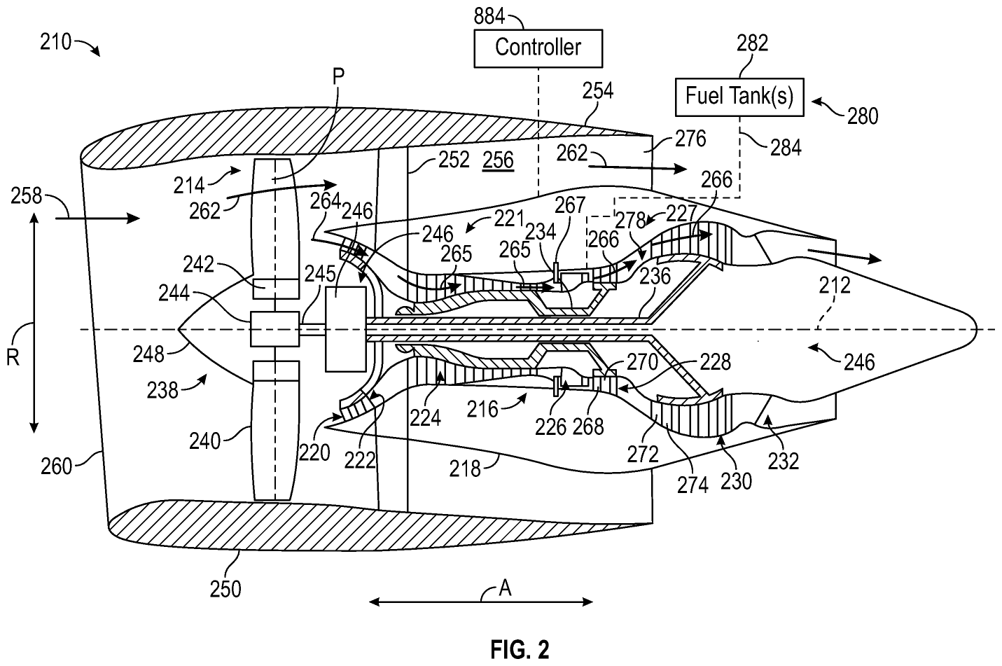

The aircraft 10 also includes a propulsion system. The exemplary propulsion system depicted includes a plurality of engines 42, at least one of which is mounted to each of the plurality of wings 22. Specifically, the plurality of engines 42 includes a first engine 42a mounted to the first wing 22a and a second engine 42b mounted to the second wing 22b. In some embodiments, the plurality of engines 42 may be configured as turbofan jet engines (see, e.g., FIG. 2) suspended beneath the plurality of wings 22 in an under-wing configuration. Alternatively, however, in other exemplary embodiments any other suitable aircraft engine may be provided.

The fuel storage system 11 includes one or more fuel tanks 46 (shown schematically by dashed lines in FIG. 1A) for storing one or more types of fuels that are used in the propulsion system, for example, by the plurality of engines 42. The fuels include a kerosene-based jet fuel, such as, for example, Jet A, Jet A-1, jet propellant 5 (JP-5), or jet propellant 8 (JP-8). The fuels can include any type of aviation fuel used to power aircraft. The one or more fuel tanks 46 include a first fuel tank 46a located in the fuselage 20 adjacent to a location where the wings 22 are coupled to the fuselage 20. In some embodiments, the one or more fuel tanks 46 include one or more second fuel tanks 46b. At least a portion of the one or more second fuel tanks 46b is located in the wings 22. For example, the first wing 22a includes a second fuel tank 46b and the second wing 22b includes a second fuel tank 46b. The one or more fuel tanks 46 may be located at any suitable locations along the fuselage 20, the wings 22, or the plurality of engines 42. The one or more fuel tanks 46 may be made from any type of fuel tank material, such as, for example, titanium, steel, aluminum, alloys, composites, or the like.

FIG. 2 is a schematic cross-sectional diagram of a turbine engine 210, taken along a centerline axis of the turbine engine 210, according to an embodiment of the present disclosure. The turbine engine 210 can be utilized for the plurality of engines 42 shown in FIGS. 1A and 1B. As shown in FIG. 2, the turbine engine 210 defines an axial direction A (extending parallel to a longitudinal centerline axis 212 provided for reference) and a radial direction R that is normal to the axial direction A. In general, the turbine engine 210 includes a fan section 214 and a core turbine engine 216 disposed downstream from the fan section 214.

The core turbine engine 216 depicted generally includes an outer casing 218 that is substantially tubular and defines an annular inlet 220. As schematically shown in FIG. 2, the outer casing 218 encases, in serial flow relationship, a compressor section 221 including a booster or a low pressure (LP) compressor 222 followed downstream by a high pressure (HP) compressor 224, a combustion section 226, a turbine section 227 including a high pressure (HP) turbine 228 followed downstream by a low pressure (LP) turbine 230, and a jet exhaust nozzle section 232. A high pressure (HP) shaft 234 or a spool drivingly connects the HP turbine 228 to the HP compressor 224 to rotate the HP turbine 228 and the HP compressor 224 in unison. A low pressure (LP) shaft 236 drivingly connects the LP turbine 230 to the LP compressor 222 to rotate the LP turbine 230 and the LP compressor 222 in unison. The compressor section 221, the combustion section 226, the turbine section 227, and the jet exhaust nozzle section 232 together define a core air flowpath.

For the embodiment depicted in FIG. 2, the fan section 214 includes a fan 238 (e.g., a variable pitch fan) having a plurality of fan blades 240 coupled to a disk 242 in a spaced apart manner. As depicted in FIG. 2, the fan blades 240 extend outwardly from the disk 242 generally along the radial direction R. Each fan blade 240 is rotatable relative to the disk 242 about a pitch axis P by virtue of the fan blades 240 being operatively coupled to an actuation member 244 configured to collectively vary the pitch of the fan blades 240 in unison. The fan blades 240, the disk 242, and the actuation member 244 are together rotatable about the longitudinal centerline axis 212 via a fan shaft 245 that is powered by the LP shaft 236 across a power gearbox, also referred to as a gearbox assembly 246. The gearbox assembly 246 is shown schematically in FIG. 2. The gearbox assembly 246 includes a plurality of gears for adjusting the rotational speed of the fan shaft 245 and, thus, the fan 238 relative to the LP shaft 236 to a more efficient rotational fan speed.

Referring still to the embodiment of FIG. 2, the disk 242 is covered by a rotatable fan hub 248 aerodynamically contoured to promote an airflow through the plurality of fan blades 240. In addition, the fan section 214 includes an annular fan casing or a nacelle 250 that circumferentially surrounds the fan 238 and/or at least a portion of the core turbine engine 216. The nacelle 250 is supported relative to the core turbine engine 216 by a plurality of circumferentially spaced outlet guide vanes 252. Moreover, a downstream section 254 of the nacelle 250 extends over an outer portion of the core turbine engine 216 to define a bypass airflow passage 256 therebetween.

During operation of the turbine engine 210, a volume of air 258 enters the turbine engine 210 through an inlet 260 of the nacelle 250 and/or the fan section 214. As the volume of air 258 passes across the fan blades 240, a first portion of air 262 is directed or routed into the bypass airflow passage 256, and a second portion of air 264 is directed or routed into the upstream section of the core air flowpath, or, more specifically, into the annular inlet 220 of the LP compressor 222. The ratio between the first portion of air 262 and the second portion of air 264 is commonly known as a bypass ratio. The pressure of the second portion of air 264 is then increased, generating compressed air 265, and the compressed air 265 is routed through the HP compressor 224 and into the combustion section 226, where the compressed air 265 is mixed with fuel 267 and burned to generate combustion gases 266.

The combustion gases 266 are routed into the HP turbine 228 and expanded through the HP turbine 228 where a portion of thermal and/or of kinetic energy from the combustion gases 266 is extracted via sequential stages of HP turbine stator vanes 268 that are coupled to the outer casing 218 and HP turbine rotor blades 270 that are coupled to the HP shaft 234, thus, causing the HP shaft 234 to rotate, thereby supporting operation of the HP compressor 224. The combustion gases 266 are then routed into the LP turbine 230 and expanded through the LP turbine 230. Here, a second portion of thermal and kinetic energy is extracted from the combustion gases 266 via sequential stages of LP turbine stator vanes 272 that are coupled to the outer casing 218 and LP turbine rotor blades 274 that are coupled to the LP shaft 236, thus, causing the LP shaft 236 to rotate, thereby supporting operation of the LP compressor 222 and rotation of the fan 238 via the gearbox assembly 246.

The combustion gases 266 are subsequently routed through the jet exhaust nozzle section 232 of the core turbine engine 216 to provide propulsive thrust. Simultaneously, the pressure of the first portion of air 262 is substantially increased as the first portion of air 262 is routed through the bypass airflow passage 256 before being exhausted from a fan nozzle exhaust section 276 of the turbine engine 210, also providing propulsive thrust. The HP turbine 228, the LP turbine 230, and the jet exhaust nozzle section 232 at least partially define a hot gas path 278 for routing the combustion gases 266 through the core turbine engine 216.

As detailed above, the second portion of air 264 is mixed with the fuel 267 in the combustion section 226 to produce the combustion gases 266. The turbine engine 210 also includes a fuel delivery system 280 for providing the fuel 267 to the combustion section 226. The fuel delivery system 280 includes a fuel tank 282 and one or more fuel lines 284 that form a fuel flowpath from the fuel tank 282 to the combustion section 226. The fuel delivery system 280 can be considered part of the aircraft 10 (FIGS. 1A and 1B). For example, the fuel tank 282 can be utilized as the one or more fuel tanks 46 of FIG. 1A.

The turbine engine 210 depicted in FIG. 2 is by way of example only. In other exemplary embodiments, the turbine engine 210 may have any other suitable configuration. For example, in other exemplary embodiments, the fan 238 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop, and/or turboshaft engines.

A controller 884 is in communication with the turbine engine 210 for controlling aspects of the turbine engine 210. For example, the controller 884 is in two-way communication with the turbine engine 210 for receiving signals from various sensors and control systems of the turbine engine 210, and for controlling aircraft components (e.g., components or systems of the turbine engine 210 and/or components or systems of the aircraft 10 of FIGS. 1A and 1B), as detailed further below. The controller 884, or components thereof, may be located onboard the turbine engine 210, onboard the aircraft 10 (FIGS. 1A and 1B), or can be located remote from each of the turbine engine 210 and the aircraft 10. For example, the controller 884 can be a Full Authority Digital Engine Control (FADEC) that controls the fuel control systems (e.g., fuel cooling system fuel pumps) disclosed herein, as detailed further below.

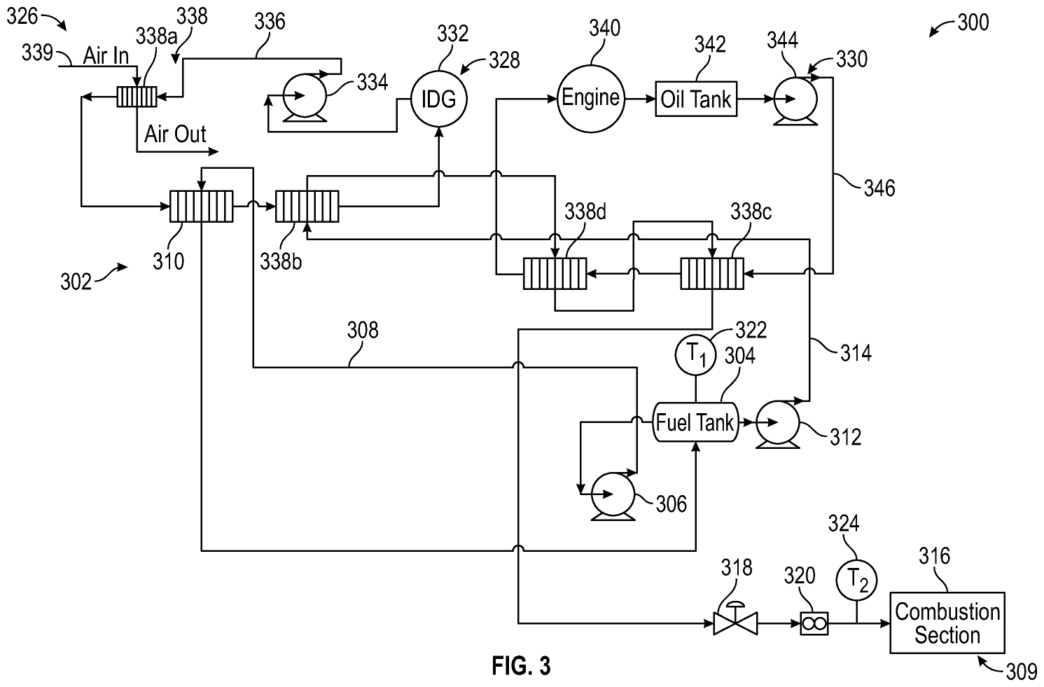

FIG. 3 is a schematic flow diagram of a fuel system 300 with a fuel cooling system 302 for the turbine engine 210 of FIG. 2, according to the present disclosure. The fuel cooling system 302 includes a fuel tank 304, a fuel cooling system fuel pump 306, a fuel cooling system fuel line 308, and one or more fuel cooling system heat exchangers 310. The fuel tank 304 stores fuel, such as a liquid fuel as detailed above. The fuel cooling system fuel pump 306, as well as any other pump included in the fuel system 300, can have any suitable configuration. For example, the fuel cooling system fuel pump 306 can be powered by an electrical input, can be a turbopump (e.g., comprising a turbine and a pump), etc. The fuel cooling system fuel pump 306 is in fluid communication with the fuel tank 304 and pumps, or drives, the fuel from the fuel tank 304 along the fuel cooling system fuel line 308. The fuel flows through the fuel cooling system fuel line 308 and directs the fuel to a thermal management system 326 to cool one or more aircraft components, such as, for example, components or systems of the turbine engine (e.g., the turbine engine 210 of FIG. 2) and/or components or systems of the aircraft (e.g., the aircraft 10 of FIGS. 1A and 1B), as detailed further below. The controller 884 (FIG. 2) controls the fuel cooling system fuel pump 306 to pump the fuel from the fuel tank 304 and into the fuel cooling system fuel line 308.

The fuel system 300 includes a fuel delivery system 309 that includes a fuel delivery system fuel pump 312 and a fuel delivery system fuel line 314. The fuel delivery system fuel pump 312 can have any suitable configuration. For example, the fuel delivery system fuel pump 312 can be powered by an electrical input, can be a turbopump (e.g., comprising a turbine and a pump), etc. The fuel delivery system fuel pump 312 is in fluid communication with the fuel tank 304 and pumps, or drives, the fuel from the fuel tank 304 along the fuel delivery system fuel line 314. The fuel flows through the fuel delivery system fuel line 314 and directs the fuel to a combustion section 316 of an engine, where the fuel mixes with air to generate a fuel-air mixture and the fuel-air mixture is burned to generate combustion gases. The combustion section 316 can be utilized as the combustion section 226 of FIG. 2. The controller 884 (FIG. 2) controls the fuel delivery system fuel pump 312 to pump the fuel from the fuel tank 304 and into the fuel delivery system fuel line 314.

In some embodiments, the fuel delivery system fuel line 314 includes a metering valve 318 and a flowmeter 320. The metering valve 318 is used to control the flow rate of the fuel in the fuel delivery system fuel line 314 to the combustion section 316 to ensure a constant flow rate of the fuel to the combustion section 316. The flowmeter 320 is a sensor that measures the flow rate of the fuel in the fuel delivery system fuel line 314 to the combustion section 316. A controller (e.g., the controller 884 of FIG. 2) can be used to control actuation of the metering valve 318 based on the flow rate measurements of the flowmeter 320.

The fuel system 300 also includes one or more temperature sensors for measuring a temperature of the fuel. The one or more temperature sensors include a first temperature sensor 322 at the fuel tank 304 for measuring a first temperature T₁ of the fuel in the fuel tank 304 and generating a first temperature signal indicative of the first temperature T₁. The one or more temperature sensors also include a second temperature sensor 324 at the fuel delivery system fuel line 314 for measuring a second temperature T₂ of the fuel in the fuel delivery system fuel line 314 and generating a second temperature signal indicative of the second temperature T₂. The second temperature sensor 324 is positioned in the fuel delivery system fuel line 314 downstream of the metering valve 318 and upstream of the combustion section 316. In this way, the second temperature sensor 324 measures the second temperature T₂ of the fuel just prior to the fuel being delivered to the combustion section 316. A controller (e.g., the controller 884 shown in FIG. 2) receives the temperature signals from the first temperature sensor 322 and from the second temperature sensor 324, and controls aspects of the fuel system 300, as detailed further below.

The fuel system 300 includes the thermal management system 326. The thermal management system 326 manages thermal transients of one or more systems of the engine (e.g., the turbine engine 210 of FIG. 2) and/or of the aircraft 10 (FIGS. 1A and 1B) in which the engine is installed. For example, to manage thermal transients, the thermal management system 326 is used to cool one or more thermal loads of the engine or of the aircraft. To improve propulsive efficiency of the engine, the thermal management system 326 is used to heat the fuel and to store the heated fuel for use during certain operational modes of the engine or of the aircraft, as detailed further below.

The thermal management system 326 includes the fuel cooling system 302. The thermal management system 326 also includes one or more cooling systems including a first cooling system 328 and a second cooling system 330. The first cooling system 328 includes an integrated drive generator (IDG) 332, a first oil pump 334, a first oil line 336, and one or more cooling system heat exchangers 338. The one or more cooling system heat exchangers 338 of the first cooling system 328 include one or more first cooling system heat exchangers 338a and one or more second cooling system heat exchangers 338b. The first cooling system 328 can be utilized as a cooling system for cooling oil for the IDG 332. The IDG 332 is an electrical generator for powering electrical systems and/or control systems of the aircraft. For example, the IDG 332 uses kinetic energy from the engines and converts the kinetic energy into electrical energy. The first oil pump 334 is in fluid communication with the IDG 332 and pumps, or drives, oil from the IDG 332 (or from an oil tank) along the first oil line 336. In this way, the oil is circulated to flow through the first oil line 336.

The one or more first cooling system heat exchangers 338a include a heat exchanger that includes the first oil line 336 and an air flowpath 339. For example, the one or more first cooling system heat exchangers 338a include an air-cooled oil cooler, also referred to as a liquid-to-air heat exchanger. In operation, cooling air (e.g., ambient air) flows through the air flowpath 339 into the one or more first cooling system heat exchangers 338a (e.g., “Air In”) to cool the oil in the first oil line 336 as the oil passes through the one or more first cooling system heat exchangers 338a. For example, the air passes along an outer surface of the first oil line 336 within the one or more first cooling system heat exchangers 338a to cool the oil in the first oil line 336 as the oil passes through the one or more first cooling system heat exchangers 338a. In this way, the air absorbs heat from the oil in the one or more first cooling system heat exchangers 338a. The air is then directed out of the one or more first cooling system heat exchangers 338a and subsequently out of the aircraft (e.g., “Air Out”). The oil in the first oil line 336 then flows to the one or more fuel cooling system heat exchangers 310. In the embodiment of FIG. 3, the one or more fuel cooling system heat exchangers 310 are part of the first cooling system 328.

The one or more fuel cooling system heat exchangers 310 are heat exchangers that include the first oil line 336 and the fuel cooling system fuel line 308. In this way, the one or more fuel cooling system heat exchangers 310 are fuel-cooled oil coolers, also referred to as liquid-to-fuel heat exchangers. For example, the fuel cooling system fuel line 308, and, thus, the fuel in the fuel cooling system fuel line 308, passes through the one or more fuel cooling system heat exchangers 310. In operation, the fuel flows through the fuel cooling system fuel line 308 into the one or more fuel cooling system heat exchangers 310 to cool the oil in the first oil line 336 as the oil passes through the one or more fuel cooling system heat exchangers 310. For example, the fuel passes along an outer surface of the first oil line 336 within the one or more fuel cooling system heat exchangers 310 to cool the oil in the first oil line 336 as the oil passes through the one or more fuel cooling system heat exchangers 310. In this way, the fuel in the fuel cooling system fuel line 308 absorbs heat from the oil in the one or more fuel cooling system heat exchangers 310. The oil in the first oil line 336 is then directed to the one or more second cooling system heat exchangers 338b. In this way, the fuel in the fuel cooling system fuel line 308 absorbs heat from the oil in the first oil line 336, and the fuel cooling system 302 is part of the first cooling system 328. The heated fuel in the fuel cooling system fuel line 308 flows back to the fuel tank 304, and the heated fuel is stored in the fuel tank 304.

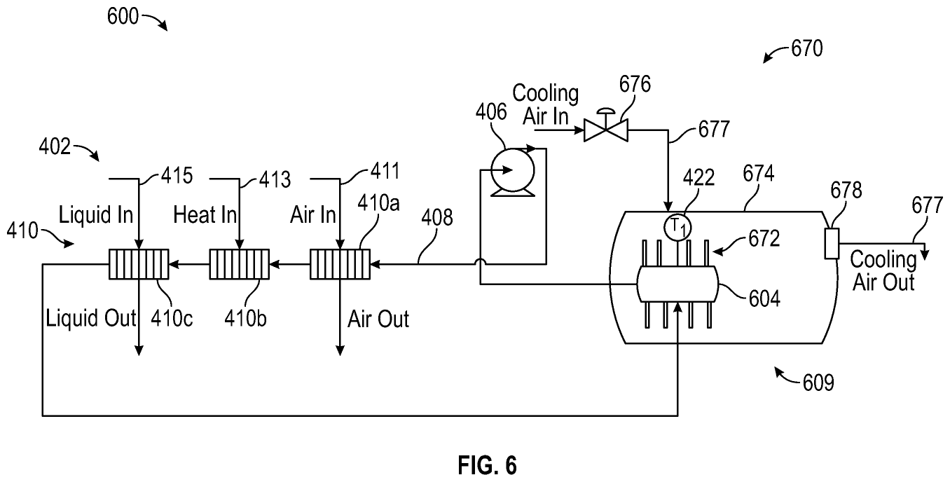

Accordingly, the fuel in the fuel cooling system fuel line 308 is circulated from the fuel tank 304 (e.g., pumped from the fuel tank 304 by the fuel cooling system fuel pump 306), absorbs heat from one or more aircraft components (e.g., via one or more heat exchangers), and the heated fuel returns to the fuel tank 304. The heated fuel in the fuel tank 304 can then be circulated through the fuel delivery system fuel line 314 to the combustion section 316, as detailed further below. Therefore, the fuel cooling system 302 circulates the fuel from the fuel tank 304 separately from the fuel delivery system fuel line 314 that circulates the fuel in the fuel tank 304 to the combustion section 316. The fuel cooling system 302 allows the one or more first cooling system heat exchangers 338a to be smaller than a first cooling system heat exchanger of current thermal management systems (e.g., 10 kW versus 100 kW), and, thus, allows for a reduced weight compared current thermal management systems. In some embodiments, the fuel tank 304 includes a fuel tank heat rejection system (e.g., the fuel tank heat rejection system 670 of FIG. 6, detailed below) to reject the heat from the fuel in the fuel tank 304. In some embodiments, the fuel tank 304 includes a fuel cooler (e.g., a heat exchanger) that cools the fuel in the fuel tank 304.

The one or more second cooling system heat exchangers 338b include a heat exchanger that includes the first oil line 336 and the fuel delivery system fuel line 314. For example, the one or more second cooling system heat exchangers 338b include a fuel-cooled oil cooler, also referred to a liquid-to-fuel heat exchanger. The fuel delivery system fuel line 314, and, thus, the fuel in the fuel delivery system fuel line 314, passes through the one or more second cooling system heat exchangers 338b. In operation, the fuel flows through the fuel delivery system fuel line 314 and into the one or more second cooling system heat exchangers 338b to cool the oil in the first oil line 336 as the oil passes through the one or more second cooling system heat exchangers 338b. For example, the fuel passes along an outer surface of the first oil line 336 within the one or more second cooling system heat exchangers 338b to cool the oil in the first oil line 336 as the oil passes through the one or more second cooling system heat exchangers 338b. In this way, the fuel in the fuel delivery system fuel line 314 absorbs heat from the oil in the one or more second cooling system heat exchangers 338b. The oil in the first oil line 336 is then directed back to the IDG 332 to cool and to lubricate components of the IDG 332. The oil is then recirculated to flow through the first oil line 336. The fuel in the fuel delivery system fuel line 314 is directed from the one or more second cooling system heat exchangers 338b to the second cooling system 330, as detailed further below.

The second cooling system 330 includes an engine 340, an oil tank 342, a second oil pump 344, a second oil line 346, one or more cooling system heat exchangers 338. The one or more cooling system heat exchangers 338 of the second cooling system 330 include one or more third cooling system heat exchangers 338c and one or more fourth cooling system heat exchangers 338d. The second cooling system 330 can be utilized as a cooling system for cooling oil for the engine 340. The engine 340 can be utilized as any of the engines disclosed herein. The oil tank 342 stores oil therein and can collect spent oil from the engine 340. The second oil pump 344 pumps, or drives, oil from the oil tank 342 along the second oil line 346. In this way, the oil is circulated to flow through the second oil line 346.

The one or more third cooling system heat exchangers 338c include a heat exchanger that includes the second oil line 346 and the fuel delivery system fuel line 314. For example, the one or more third cooling system heat exchangers 338c include a fuel-cooled oil cooler, also referred to as a liquid-to-fuel heat exchanger. The fuel delivery system fuel line 314, and, thus, the fuel in the fuel delivery system fuel line 314, passes through the one or more third cooling system heat exchangers 338c. The one or more fourth cooling system heat exchangers 338d is a heat exchanger that includes the second oil line 346 and the fuel delivery system fuel line 314. For example, the one or more fourth cooling system heat exchangers 338d is a fuel-cooled oil cooler. The fuel delivery system fuel line 314, and, thus, the fuel in the fuel delivery system fuel line 314, passes through the one or more fourth cooling system heat exchangers 338d.

In operation, the oil flows through the second oil line 346, through the one or more third cooling system heat exchangers 338c, through the one or more fourth cooling system heat exchangers 338d, and is then directed to the engine 340 to cool and to lubricate turbine engine components of the engine 340. Spent oil is then collected back into the oil tank 342 and the oil in the oil tank 342 can be recirculated to flow through the second oil line 346. At the same time, the fuel in the fuel delivery system fuel line 314 passes through the one or more third cooling system heat exchangers 338c and passes through the one or more fourth cooling system heat exchangers 338d to cool the oil. As the oil passes through the one or more third cooling system heat exchangers 338c, the fuel flows through the fuel delivery system fuel line 314 into the one or more third cooling system heat exchangers 338c to cool the oil in the second oil line 346. For example, the fuel passes along an outer surface of the second oil line 346 within the one or more third cooling system heat exchangers 338c to cool the oil in the second oil line 346 as the oil passes through the one or more third cooling system heat exchangers 338c. In this way, the fuel in the fuel delivery system fuel line 314 absorbs heat from the oil in the one or more third cooling system heat exchangers 338c. Similarly, as the oil passes through the one or more fourth cooling system heat exchangers 338d, the fuel flows through the fuel delivery system fuel line 314 into the one or more fourth cooling system heat exchangers 338d to cool the oil in the second oil line 346. For example, the fuel passes along an outer surface of the second oil line 346 within the one or more fourth cooling system heat exchangers 338d to cool the oil in the second oil line 346 as the oil passes through the one or more fourth cooling system heat exchangers 338d. In this way, the fuel in the fuel delivery system fuel line 314 absorbs heat from the oil in the one or more fourth cooling system heat exchangers 338d.

The oil in the second oil line 346 is then directed back to the engine 340 to cool and to lubricate turbine engine components of the engine 340. The oil is then recirculated to flow through the second oil line 346. In the exemplary embodiment, the fuel in the fuel delivery system fuel line 314 is directed from the one or more second cooling system heat exchangers 338b to the one or more fourth cooling system heat exchangers 338d, and from the one or more fourth cooling system heat exchangers 338d to the one or more third cooling system heat exchangers 338c. The thermal management system 326, however, can include any arrangement of heat exchangers, and any type of heat exchanger, for cooling aircraft components (e.g., components or systems of the engine and/or components or systems of the aircraft). The fuel is then directed to the combustion section 316 to mix with air and is ignited to produce combustion gases, as detailed above. In this way, the temperature of the fuel increases as the fuel flows through the fuel delivery system fuel line 314 and absorbs heat through the heat exchangers. The heated fuel is then delivered to the combustion section 316 and provides improved propulsive efficiency for the engine. The fuel in the fuel delivery system fuel line 314 is directed to the combustion section 316 and is not returned to the fuel tank 304. Accordingly, the fuel system 300 provides for the fuel cooling system 302 that circulates fuel from the fuel tank 304 to absorb heat from one or more aircraft components, and returns the heated fuel to the fuel tank 304. The fuel system 300 provides for the fuel delivery system fuel line 314 being separate from the fuel cooling system 302, such that the fuel in the fuel delivery system fuel line 314 is not returned to be stored in the fuel tank 304.

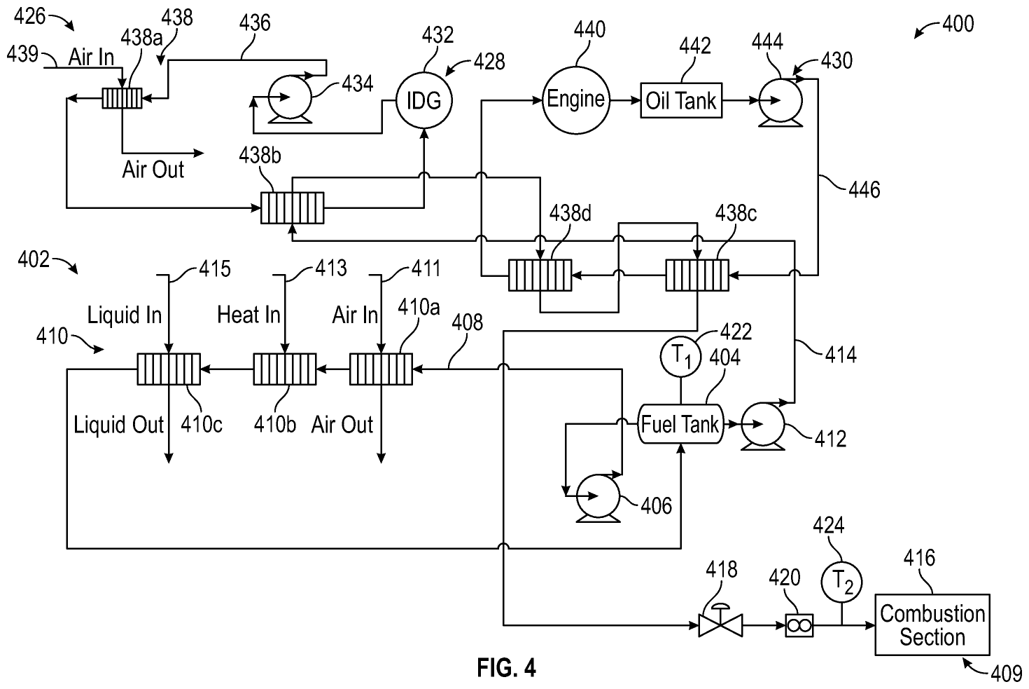

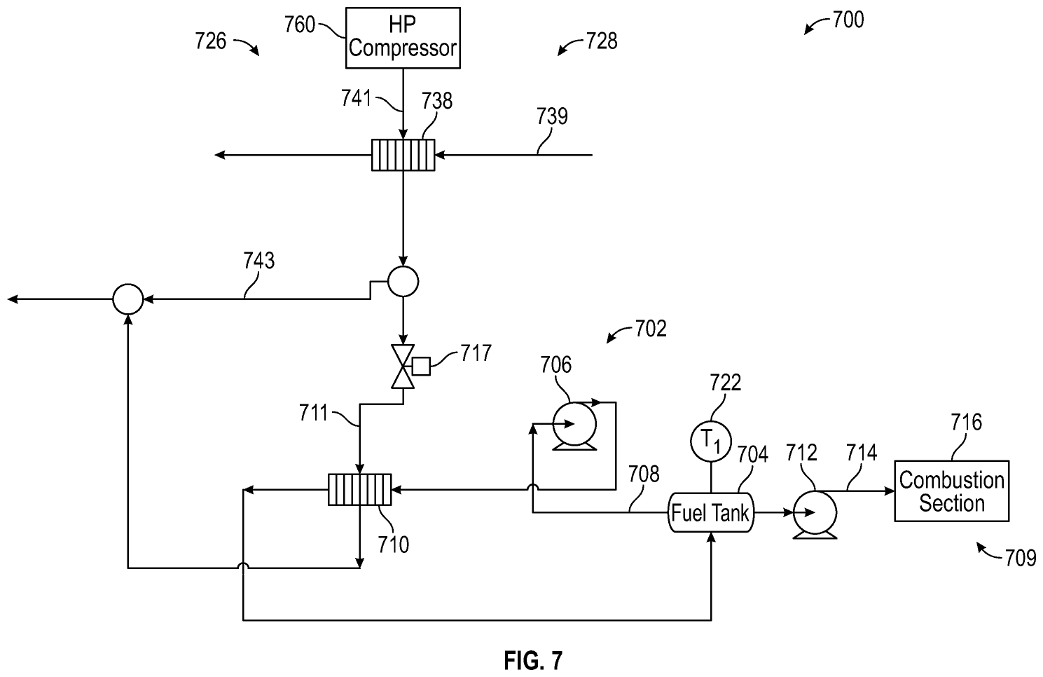

While the one or more fuel cooling system heat exchangers 310 are described as part of the first cooling system 328, the one or more fuel cooling system heat exchangers 310 can be part of any system of the aircraft and/or of the turbine engines, such as, for example, a main lubrication system (FIG. 3), a compressor cooling air (CCA) system (FIG. 4), an active thermal clearance control (ACC) system, a generator lubrication system (FIG. 3), an environmental control system (ECS) (FIG. 7), and/or an electronics cooling system. Accordingly, the thermal management systems detailed herein may transfer heat from a variety of independent systems to the fuel in the fuel cooling system.

FIG. 4 is a schematic flow diagram of a fuel system 400 with a fuel cooling system 402 for a turbine engine, according to another embodiment. The fuel system 400 and the fuel cooling system 402 can be used in the turbine engine 210 of FIG. 2. The fuel system 400 is similar to the fuel system 300 shown in FIG. 3, and the same or similar components operate as detailed above, and are labeled with similar reference numbers.

The fuel cooling system 402 includes a fuel tank 404, a fuel cooling system fuel pump 406, a fuel cooling system fuel line 408, and one or more fuel cooling system heat exchangers 410. The fuel cooling system fuel pump 406 is in fluid communication with the fuel tank 404 and pumps, or drives, the fuel from the fuel tank 404 along the fuel cooling system fuel line 408. The fuel flows through the fuel cooling system fuel line 408 and directs the fuel to a thermal management system 426 to cool one or more aircraft components, such as, for example, components or systems of the turbine engine (e.g., the turbine engine 210 of FIG. 2) and/or components or systems of the aircraft (e.g., the aircraft 10 of FIGS. 1A and 1B), as detailed further below. The controller 884 (FIG. 2) controls the fuel cooling system fuel pump 406 to pump the fuel from the fuel tank 404 and into the fuel cooling system fuel line 408.

The one or more fuel cooling system heat exchangers 410 include one or more first fuel cooling system heat exchangers 410a, one or more second fuel cooling system heat exchangers 410b, and one or more third fuel cooling system heat exchangers 410c. The fuel cooling system 402 can include any number, and any combination, of first fuel cooling system heat exchangers 410a, second fuel cooling system heat exchangers 410b, and/or third fuel cooling system heat exchangers 410c. The one or more first fuel cooling system heat exchangers 410a, the one or more second fuel cooling system heat exchangers 410b, and the one or more third fuel cooling system heat exchangers 410c can be arranged in any order as desired.

The one or more first fuel cooling system heat exchangers 410a include a heat exchanger that includes the fuel cooling system fuel line 408 and an air flowpath 411. For example, the one or more first fuel cooling system heat exchangers 410a is a fuel-cooled air cooler, also referred to as an air-to-fuel heat exchanger. In operation, hot air (e.g., from the turbine section 227 or from the compressor section 221 in FIG. 2) flows through the air flowpath 411 into the first fuel cooling system heat exchanger 410a (e.g., “Air In”). At the same time, the fuel in the fuel cooling system fuel line 408 passes through the one or more first fuel cooling system heat exchangers 410a to cool the air in the air flowpath 411 as the air passes through the one or more first fuel cooling system heat exchangers 410a. For example, the air passes along an outer surface of the fuel cooling system fuel line 408 within the one or more first fuel cooling system heat exchangers 410a to cool the air in the air flowpath 411. In this way, the fuel absorbs heat from the air in the one or more first fuel cooling system heat exchangers 410a. The air is then directed out of the one or more first fuel cooling system heat exchangers 410a (e.g., “Air Out”) and subsequently to one or more cooling systems (e.g., to cool avionics, the aircraft cabin, or other components) and/or back to the turbine section 227 (FIG. 2) to cool the turbine section 227 or to the compressor section 221 (FIG. 2) to cool the compressor section 221. The fuel in the fuel cooling system fuel line 408 then flows to the one or more second fuel cooling system heat exchangers 410b.

The one or more second fuel cooling system heat exchangers 410b include a heat exchanger that includes the fuel cooling system fuel line 408 and a heat source 413 (e.g., from an IDG). For example, the one or more second fuel cooling system heat exchangers 410b include a heat sink, also referred to as a component-to-fuel heat exchanger. The heat source 413 can include any type of component of the aircraft 10 (FIGS. 1A-1B) and/or of the turbine engine 210 (FIG. 2). In operation, heat is transferred from the heat source 413 into the one or more second fuel cooling system heat exchangers 410b (e.g., “Heat In”). At the same time, the fuel in the fuel cooling system fuel line 408 passes through the one or more second fuel cooling system heat exchangers 410b to absorb the heat from the heat source 413. The fuel in the fuel cooling system fuel line 408 then flows to the one or more third fuel cooling system heat exchangers 410c.

The one or more third fuel cooling system heat exchangers 410c include a heat exchanger that includes the fuel cooling system fuel line 408 and a liquid flowpath 415. For example, the one or more third fuel cooling system heat exchangers 410c include a fuel-cooled liquid cooler, also referred to as a liquid-to-fuel heat exchanger. The liquid that passes through the one or more third fuel cooling system heat exchangers 410c can be oil, or any other liquid of the aircraft 10 (FIGS. 1A-1B) and/or the turbine engine 210 (FIG. 2) that needs to be cooled. In operation, hot liquid flows through the liquid flowpath 415 into the one or more third fuel cooling system heat exchangers 410c (e.g., “Liquid In”). At the same time, the fuel in the fuel cooling system fuel line 408 passes through the one or more third fuel cooling system heat exchangers 410c to cool the liquid in the liquid flowpath 415 as the liquid passes through the one or more third fuel cooling system heat exchangers 410c. For example, the liquid passes along an outer surface of the fuel cooling system fuel line 408 within the one or more third fuel cooling system heat exchangers 410c to cool the liquid in the liquid flowpath 415. In this way, the fuel absorbs heat from the liquid in the one or more third fuel cooling system heat exchangers 410c. The liquid is then directed out of the one or more third fuel cooling system heat exchangers 410c (e.g., “Liquid Out”) and subsequently back to the system from which the liquid came. The fuel in the fuel cooling system fuel line 408 then flows back to the fuel tank 404.

Accordingly, the fuel in the fuel tank 404 is circulated through the fuel cooling system fuel line 408 (e.g., pumped by the fuel cooling system fuel pump 406) and absorbs heat from one or more aircraft components (e.g., components or systems of the turbine engine and/or components or systems of the aircraft). The heated fuel is then directed back to the fuel tank 404 and stored in the fuel tank 404. The one or more fuel cooling system heat exchangers 410 are arranged in series such that the fuel in the fuel cooling system fuel line 408 flows into the one or more first fuel cooling system heat exchangers 410a, then into the one or more second fuel cooling system heat exchangers 410b, then into the one or more third fuel cooling system heat exchangers 410c, before being returned to the fuel tank 404. In this way, the fuel in the fuel cooling system fuel line 408 increasingly gets hotter as the fuel passes through each of the one or more fuel cooling system heat exchangers 410.

The fuel system 400 includes a fuel delivery system 409 that includes a fuel delivery system fuel pump 412 and a fuel delivery system fuel line 414. In some embodiments, the fuel system 400 includes a metering valve 418, a flowmeter 420, a first temperature sensor 422, and a second temperature sensor 424. The controller 884 (FIG. 2) controls the fuel delivery system fuel pump 412 to pump the fuel from the fuel tank 404 and into the fuel delivery system fuel line 414.

The fuel system 400 includes the thermal management system 426. The thermal management system 426 is substantially similar as the thermal management system 326 of FIG. 3, and includes one or more cooling systems including a first cooling system 428 and a second cooling system 430. The first cooling system 428 includes an integrated drive generator (IDG) 432, a first oil pump 434, a first oil line 436, and one or more cooling system heat exchangers 438. The one or more cooling system heat exchangers 438 of the first cooling system 428 include one or more first cooling system heat exchangers 438a and one or more second cooling system heat exchangers 438b. The first cooling system 428 operates in the same manner as detailed above with respect to the first cooling system 328 of FIG. 3. In the embodiment of FIG. 4, however, the one or more fuel cooling system heat exchangers 410 of the fuel cooling system 402 are not part of the first cooling system 428, and the oil in the first oil line 436 flows from the one or more first cooling system heat exchangers 438a to the one or more second cooling system heat exchangers 438b. The one or more first cooling system heat exchangers 438a include an air flowpath 439, similar to the one or more first cooling system heat exchangers 338a of FIG. 3.

The second cooling system 430 includes an engine 440, an oil tank 442, a second oil pump 444, a second oil line 446, and one or more cooling system heat exchangers 438 including one or more third cooling system heat exchangers 438c and one or more fourth cooling system heating exchangers 438d. The second cooling system 430 operates in the same manner as detailed above with respect to the second cooling system 330 of FIG. 3. The fuel in the fuel delivery system fuel line 414 is directed to the combustion section 416 and is not returned to the fuel tank 404. Accordingly, the fuel system 400 provides for the fuel cooling system 402 that circulates fuel from the fuel tank 404 to absorb heat from one or more aircraft components (e.g., components or systems of the turbine engine and/or components or systems of the aircraft), and returns the heated fuel to the fuel tank 404. The fuel system 400 provides for the fuel delivery system fuel line 414 being separate from the fuel cooling system 402, such that the fuel in the fuel delivery system fuel line 414 is not returned to be stored in the fuel tank 404.

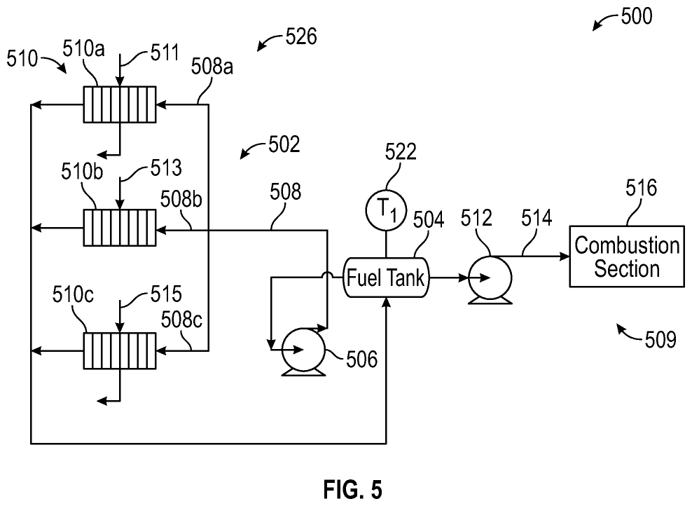

FIG. 5 is a schematic flow diagram of a fuel system 500 with a fuel cooling system 502 for a turbine engine, according to another embodiment. The fuel system 500 and the fuel cooling system 502 can be used in the turbine engine 210 of FIG. 2. The fuel system 500 is similar to the fuel system 400 of FIG. 4, and the same or similar components operate as detailed above, and are labeled with similar reference numbers.

The fuel cooling system 502 includes a fuel tank 504, a fuel cooling system fuel pump 506, a fuel cooling system fuel line 508, and one or more fuel cooling system heat exchangers 410 as part of a thermal management system 526. The fuel system 500 also includes a fuel delivery system 509 that includes a fuel delivery system fuel pump 512 and a fuel delivery system fuel line 514 that delivers fuel from the fuel tank 504 to a combustion section 516. A first temperature sensor 522 measures the temperature of the fuel in the fuel tank 504. The fuel system 500 can also include any of the components detailed above.

The one or more fuel cooling system heat exchangers 510 include one or more first fuel cooling system heat exchangers 510a, one or more second fuel cooling system heat exchangers 510b, and one or more third fuel cooling system heat exchangers 510c. The one or more first fuel cooling system heat exchangers 510a include an air flowpath 511 and operates similarly as the one or more first fuel cooling system heat exchanger 410a (FIG. 4). The one or more second fuel cooling system heat exchanger 510b include a heat source 513 and operates similarly as the one or more second fuel cooling system heat exchangers 410b (FIG. 4). The one or more third fuel cooling system heat exchangers 510c includes a liquid flowpath 515 and operates similarly as the one or more third fuel cooling system heat exchanger 410c (FIG. 4). The fuel cooling system 502 can include any number, and any combination, of first fuel cooling system heat exchangers 510a, second fuel cooling system heat exchangers 510b, and/or third fuel cooling system heat exchangers 510c. The one or more first fuel cooling system heat exchangers 510a, the one or more second fuel cooling system heat exchangers 510b, and the one or more third fuel cooling system heat exchangers 510c can be arranged in any order as desired.

The one or more fuel cooling system heat exchangers 510 of the fuel cooling system 502, however, are arranged in parallel (rather than in series). For example, the fuel cooling system fuel line 508 splits into a plurality of fuel line branches upstream of the one or more fuel cooling system heat exchangers 510. In this way, the fuel cooling system fuel line 508 includes a first fuel line branch 508a to a first fuel cooling system heat exchanger 510a, a second fuel line branch 508b to a second fuel cooling system heat exchanger 510b, and a third fuel line branch 508c to a third fuel cooling system heat exchanger 510c. Accordingly, the fuel flows into each of the fuel line branches 508a, 508b, 508c and is provided to each of the one or more fuel cooling system heat exchangers 510 in parallel. After passing through each of the one or more fuel cooling system heat exchangers 510 and absorbing heat, the heated fuel flows back to the fuel tank 504 to be stored in the fuel tank 504. The heated fuel in the fuel tank 504 can then be delivered to the combustion section 516 in the fuel delivery system fuel line 514.

FIG. 6 is a schematic flow diagram of a fuel system 600 with the fuel cooling system 402 for a turbine engine, according to another embodiment. The fuel system 600 and the fuel cooling system 402 can be used in the turbine engine 210 of FIG. 2. The fuel system 600 is similar to the fuel system 400 of FIG. 4, and the same or similar components operate as detailed above, and are labeled with similar reference numbers. For clarity, FIG. 6 does not show the components of a fuel delivery system 609, such as the fuel delivery system fuel pump, the fuel delivery system fuel line, or the components thereof. The fuel system 600, however, include such components for delivering fuel from a fuel tank 604 to a combustion section (e.g., the combustion section 226 of FIG. 2).

The fuel system 600 includes a fuel tank heat rejection system 670 for the fuel tank 604. The fuel tank 604 is located in a fuel tank compartment 674 of an aircraft, such as the aircraft 10 shown in FIGS. 1A and 1B. In the exemplary embodiment, the fuel tank 604 is utilized as the first fuel tank 46a of FIG. 1A. In some embodiments, the fuel tank 604 is located in a wing of the aircraft and is utilized as the second fuel tank 46b of FIG. 1B.

The fuel tank heat rejection system 670 includes one or more fins 672 coupled to, and extending from, the fuel tank 604. The one or more fins 672 (shown schematically in FIG. 6) provide an increased external surface area for the fuel tank 604 such that cooling air can pass over the fins to cool the fuel tank 604, as detailed further below. The one or more fins 672 can include any length, any width, and/or any thickness, as desired, for transferring heat from the fuel and out of the fuel tank 604. In FIG. 6, the one or more fins 672 include eight such fins each extending laterally from the fuel tank 604. The one or more fins 672 may include any number of fins as desired. The one or more fins 672 can extend into the fuel tank 604 and absorb heat from the fuel in the fuel tank 404. The one or more fins 672 add an increased surface area to the fuel tank 604 such that cooling air (e.g., ambient air) contacts the one or more fins 672 and cools the one or more fins 672, thereby rejecting the heat and cooling the fuel in the fuel tank 604, as detailed further below.

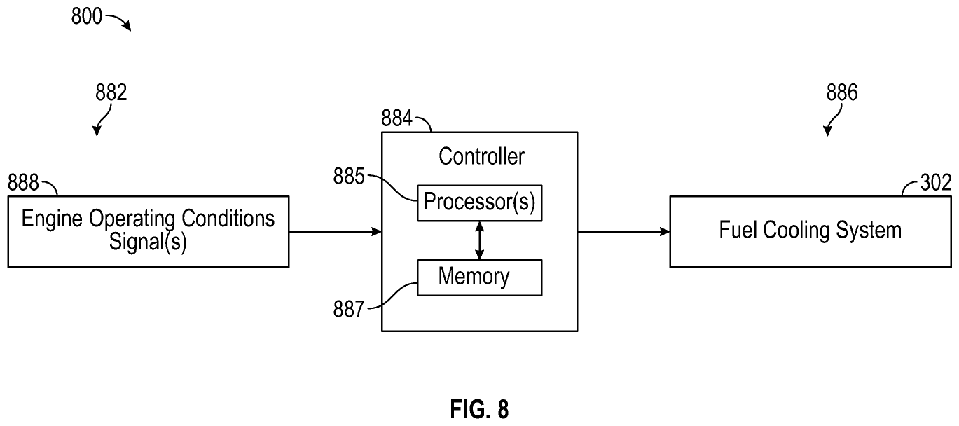

The fuel tank heat rejection system 670 also includes one or more air valves 676 and one or more air vents 678 located on the fuel tank compartment 674. The one or more air valves 676 provide fluid communication from the atmosphere (e.g., outside the aircraft) to the fuel tank compartment 674. The one or more air valves 676 can each include any type of air valve that is controlled by a controller (e.g., the controller 884 of FIGS. 2 and 8) to open and to close. In this way, the one or more air valves 676 are controlled to open to allow cooling air, such as ambient air 677, into the fuel tank compartment 674 (e.g., “Cooling Air In”). The one or more air vents 678 provide fluid communication from the fuel tank compartment 674 to the atmosphere. The one or more air vents 678 are controlled by the controller to open and to close. In this way, the one or more air vents 678 are controlled to open to allow the ambient air 677 to exit the fuel tank compartment 674 (e.g., “Cooling Air Out”). In some embodiments, the cooling air is provided by a pump, such as an air pump, and/or can be provided from other systems of the aircraft or of the engines.

In operation, the fuel cooling system 402 absorbs heat to heat the fuel in the fuel cooling system fuel line 408, and the heated fuel is directed through the fuel cooling system fuel line 408 into the fuel tank 604, as detailed above. The fuel tank 604 stores the heated fuel and the heated fuel increases the temperature of the fuel tank 604. The one or more fins 672 absorb the heat from the heated fuel in the fuel tank 604. When the temperature (e.g., the first temperature T₁) of the fuel in the fuel tank 604 increases above a high temperature threshold, the fuel tank heat rejection system 670 is controlled to open and to allow ambient air 677 into the fuel tank compartment 674. For example, the one or more air valves 676 and the one or more air vents 678 are controlled to open, and the ambient air 677 flows through the fuel tank compartment 674. While the one or more air valves 676 and the one or more air vents 678 are open, the ambient air 677 is operably directed into the fuel tank compartment 674 and is operably directed to pass by, and to contact, each of the one or more fins 672 and to exit through the one or more air vents 678. When the one or more air valves 676 and the one or more air vents 678 are open, the ambient air 677 cools the one or more fins 672, thereby rejecting the heat from the fuel tank 604 and cooling the fuel tank 604.

The one or more air valves 676 and the one or more air vents 678 are controlled to close to prevent the ambient air 677 from entering and from exiting the fuel tank compartment 674. In this way, when the fuel in the fuel tank 604 is cooled to a predetermined temperature (or to a predetermined temperature range), the fuel tank heat rejection system 670 prevents the flow of ambient air into the fuel tank compartment 674. The one or more air valves 676 can include any number of air valves, as desired, and the one or more air vents 678 can include any number of air vents, as desired.

FIG. 7 is a schematic flow diagram of a fuel system 700 with a fuel cooling system 702 for a turbine engine, according to another embodiment. The fuel system 700 is similar to the fuel system 700 of FIG. 3, and the same or similar components operate as detailed above, and are labeled with similar reference numbers.

The fuel cooling system 702 includes a fuel tank 704, a fuel cooling system fuel pump 706, a fuel cooling system fuel line 708, and one or more fuel cooling system heat exchangers 710. The fuel cooling system fuel pump 706 is in fluid communication with the fuel tank 704 and pumps, or drives, the fuel from the fuel tank 704 along the fuel cooling system fuel line 708. The fuel flows through the fuel cooling system fuel line 708 and directs the fuel to a thermal management system 726 to cool one or more aircraft components, such as, for example, components or systems of the turbine engine (e.g., the turbine engine 210 of FIG. 2) and/or components or systems of the aircraft (e.g., the aircraft 10 of FIGS. 1A and 1B), as detailed further below. The controller 884 (FIG. 2) controls the fuel cooling system fuel pump 706 to pump the fuel from the fuel tank 704 and into the fuel cooling system fuel line 708. The one or more fuel cooling system heat exchangers 710 include a heat exchanger that includes the fuel cooling system fuel line 708 and an air flowpath 711. For example, the one or more fuel cooling system heat exchangers 710 include a fuel-cooled air cooler, also referred to as an air-to-fuel heat exchanger.

The fuel system 700 also includes a fuel delivery system 709 that includes a fuel delivery system fuel pump 712 and a fuel delivery system fuel line 714 for delivering fuel from the fuel tank 704 to a combustion section 716. Although not shown, the fuel delivery system can also include a metering valve, a flowmeter, a first temperature sensor, and a second temperature sensor. The controller 884 (FIG. 2) controls the fuel delivery system fuel pump 712 to pump the fuel from the fuel tank 704 and into the fuel delivery system fuel line 714. The fuel system 700 includes the thermal management system 726. The thermal management system 726 is utilized for an environment control system (ECS) for providing an air supply to a cabin of the aircraft for pressurization and thermal control. The thermal management system 726 includes one or more cooling systems 728 that include one or more cooling system heat exchangers 738 and one or more valves 717. The one or more cooling system heat exchangers 738 include an air-to-air heat exchanger, also referred to as a pre-cooler, for the ECS. For example, the one or more cooling system heat exchangers 738 includes an ambient air flowpath 739 and a compressor bleed air flowpath 741. The ambient air flowpath 739 receives ambient from outside of the aircraft. The compressor bleed air flowpath 741 receives bleed air from a HP compressor 760 (e.g., the HP compressor 224 of FIG. 2). In this way, the one or more cooling system heat exchangers 738 are in fluid communication with the HP compressor 760.

In operation, hot compressor bleed air (e.g., from the HP compressor 760) flows through the compressor bleed air flowpath 741 and into the one or more cooling system heat exchangers 738. At the same time, cool ambient air flows through the ambient air flowpath 739 and into the one or more cooling system heat exchangers 738. The ambient air absorbs heat from the compressor bleed air in the one or more cooling system heat exchangers 738 to cool the compressor bleed air, and the heated ambient air is then directed through the ambient air flowpath 739 to exit the aircraft. The cooled compressor bleed air is directed through a cooling system flowpath 743 to provide cool air to the cabin and/or to the avionics of the aircraft.

If additional cooling is needed, the one or more valves 717 are controlled (e.g., by the controller 884 of FIGS. 2 and 8) to be opened such that a portion of the cooled compressor bleed air flows through the air flowpath 711 and into the one or more fuel cooling system heat exchangers 710. At the same time, the fuel in the fuel cooling system fuel line 708 passes through the one or more fuel cooling system heat exchangers 710 to cool the compressor bleed air in the air flowpath 711 as the compressor bleed air passes through the one or more fuel cooling system heat exchangers 710. For example, the air passes along an outer surface of the fuel cooling system fuel line 708 within the one or more fuel cooling system heat exchangers 710 to cool the compressor bleed air in the air flowpath 711. In this way, the fuel absorbs heat from the compressor bleed air in the one or more fuel cooling system heat exchangers 710. The cooled compressor bleed air is then directed out of the one or more fuel cooling system heat exchangers 710 and subsequently to the ECS. The heated fuel in the fuel cooling system fuel line 708 then flows back to the fuel tank 704.

Accordingly, the fuel in the fuel tank 704 is circulated through the fuel cooling system fuel line 708 (e.g., pumped by the fuel cooling system fuel pump 706) and absorbs heat from the compressor bleed air. The heated fuel is then directed back to the fuel tank 704 and stored in the fuel tank 704.

Accordingly, the fuel system 700 provides for the fuel cooling system 702 that circulates fuel from the fuel tank 704 to absorb heat from one or more aircraft components (e.g., components or systems of the turbine engine and/or components or systems of the aircraft), and returns the heated fuel to the fuel tank 704. The fuel system 700 provides for the fuel delivery system fuel line 714 being separate from the fuel cooling system 702, such that the fuel in the fuel delivery system fuel line 714 is not returned to be stored in the fuel tank 704.

FIG. 8 is a schematic view of a fuel cooling control system 800 for operation and control of at least portions of the aircraft 10 (FIGS. 1A and 1B), according to the present disclosure. The fuel cooling control system 800 includes inputs 882, the controller 884, and outputs 886. The inputs 882 include one or more engine operating conditions signals 888. For example, the one or more engine operating conditions signals 888 can include one or more first temperature (T₁) signals from one or more first temperature sensors (e.g., the one or more first temperature sensors 322, 422, 522, 722), and one or more second temperature (T₂) signals from one or more second temperature sensors (e.g., the one or more second temperature sensors 324, 424). The one or more first temperature sensors can be any of the first temperature sensors detailed herein. For example, the one or more first temperature sensors are located in a fuel tank of the aircraft for measuring a temperature of the fuel in the fuel tank. The one or more T₁ signals include electrical signals indicative of a temperature of the fuel in the fuel tank. The one or more second temperature sensors can be any of the second temperature sensors detailed herein. For example, the one or more second temperature sensors are located in a fuel delivery line upstream of a combustion section of an engine of the aircraft. The one or more T₂ signals include electrical signals indicative of a temperature of the fuel in the fuel delivery line just prior to the fuel being delivered to the combustion section of the engine.

The engine operating conditions signals 888 can also include signals indicative of an engine operating cycle (e.g., taxiing, takeoff, climb, cruise, descent, or landing) from one or more sensors or derived from one or more sensors and/or one or more maps. The signals indicative of the engine operating cycle can include engine temperature signals, engine power signals from one or more power sensors, engine thrust signals, engine pressure signals (e.g., pressure of air exiting the HP compressor), or any other signals that indicate that the turbine engine is operating in a particular engine operating cycle.

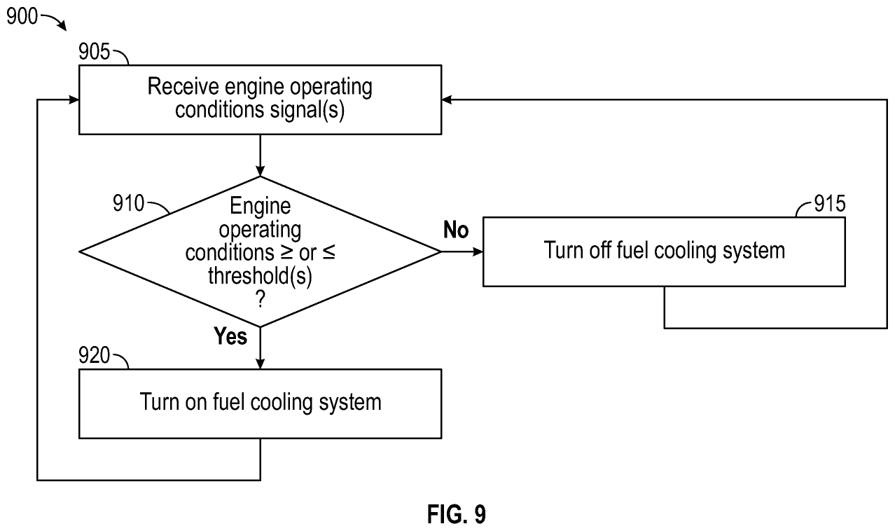

The outputs 886 include control of the fuel cooling system 302 (FIG. 3). While reference is made to the fuel cooling system 302, the fuel cooling control system 800 can include any of the fuel cooling systems detailed herein. Control of the fuel cooling system 302 includes control of the fuel cooling system fuel pump 306 (FIG. 3). The controller 884 receives the inputs 882, implements a method of cooling one or more aircraft components, and controls the outputs 886, as described with reference to FIG. 9 below.

The controller 884 may be a standalone controller or may be part of an aircraft controller or an engine controller to operate various systems of the aircraft and/or the engines. In this embodiment, the controller 884 is a computing device having one or more processors 885 and a memory 887. The one or more processors 885 can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory 887 can include one or more computer-readable media, including, but not limited to, non-transitory computer-readable media, a computer readable non-volatile medium (e.g., a flash memory), a random-access memory (RAM), a read-only memory (ROM), hard drives, flash drives, or other memory devices.

The memory 887 can store information accessible by the one or more processors 885, including computer-readable instructions that can be executed by the one or more processors 885. The instructions can be any set of instructions or a sequence of instructions that, when executed by the one or more processors 885, cause the one or more processors 885 and the controller 884 to perform operations. The controller 884 and, more specifically, the one or more processors 885 are programmed or configured to perform these operations, such as the operations discussed further below. In some embodiments, the instructions can be executed by the one or more processors 885 to cause the one or more processors 885 to complete any of the operations and functions for which the controller 884 is configured, as will be described further below. The instructions can be software written in any suitable programming language or can be implemented in hardware. Additionally, or alternatively, the instructions can be executed in logically or virtually separate threads on the processors 885. The memory 887 can further store data that can be accessed by the one or more processors 885.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The controller 884 is communicatively coupled to the one or more first temperature sensors (e.g., the first temperature sensor 322 of FIG. 3) and to the one or more second temperature sensors (e.g., the second temperature sensor 324 of FIG. 3), and to any other sensors for determining engine operating conditions. The controller 884 is communicatively coupled to the fuel cooling system fuel pump 306. The controller 884 receives the inputs 882, determines the engine operating conditions, and controls the outputs 886, as detailed further below.

FIG. 9 is a flow diagram of a method 900 of cooling one or more aircraft components, according to the present disclosure. For the method 900, reference is made to FIGS. 1A, 1B, 3, and 8. The fuel cooling system, however, can be any of the fuel cooling systems detailed herein. The method 900 proceeds after the aircraft and the engines are powered on.

In step 905, the controller 884 receives the engine operating conditions signals 888. For example, the controller 884 receives the one or more T₁ signals, the one or more T₂ signals, or any of the other signals that indicate engine operating conditions of the turbine engine. The controller 884 determines the engine operating conditions based on the engine operating conditions signals 888.

In step 910, the controller 884 determines whether the engine operating conditions are outside (e.g., greater than or equal to, or less than or equal to) one or more thresholds. The controller 884 can compare the engine operating conditions to one or more thresholds and determine whether engine operating conditions are outside (e.g., exceed, are equal to, or are lower than) the one or more thresholds. For example, the controller 884 can determine whether T₁ and/or T₂ is greater than or equal to a high temperature threshold T_{H} or less than or equal to a low temperature threshold T_{L}. If the temperature of the fuel increases above the high temperature threshold T_{H}, the fuel can begin to cook and carbonaceous deposits (also known as coke) form in the fuel, thereby reducing the propulsive efficiency of the turbine engines. Thus, the high temperature threshold T_{H} corresponds to a temperature of the fuel just before the fuel cooks and coke is produced in the fuel. In some embodiments, the high temperature threshold T_{H} is three hundred degrees Fahrenheit (300° F.). The high temperature threshold T_{H}, however, can be any temperature, as desired.

If the temperature of the fuel decreases below the low temperature threshold T_{L}, the fuel can become excessively viscous such that performance of the combustion section is reduced. Thus, the low temperature threshold T_{L} corresponds to a temperature just before the fuel becomes excessively viscous such that performance of the combustion section is reduced. In some embodiments, the low temperature threshold T_{L} is forty degrees Fahrenheit (40° F.). The low temperature threshold T_{L}, however, can be any temperature, as desired.

The controller 884 can also determine whether the engine power is greater than, equal to, or less than an engine power threshold, whether the engine pressure is greater than, equal to, or less than an engine pressure threshold, and/or whether the engine thrust is greater than, equal to, or less than an engine thrust threshold. In this way, the controller 884 can control the fuel cooling system 302 based on a temperature of the fuel, engine power, engine pressure, and/or engine thrust.

In step 915, if the engine operating conditions are not outside (e.g., are not greater than or equal to, or are not less than or equal to) the one or more thresholds (step 910: No), the controller 884 turns off the fuel cooling system 302. To turn off the fuel cooling system 302, the controller 884 controls the fuel cooling system fuel pump 306 to prevent fuel from being pumped out of the fuel tank 304 and into the fuel cooling system fuel line 308. In this way, the fuel is not circulated through the fuel cooling system 302 when the fuel cooling system 302 is turned off, and the fuel in the fuel tank 304 is not heated by the fuel cooling system 302. In some examples, the controller 884 turns off the fuel cooling system 302 if the fuel in the fuel tank 304 is above the high temperature threshold T_{H}, if the engine power is less than or equal to the engine power threshold, if the engine pressure is less than or equal to the engine pressure threshold, and/or if the engine thrust is less than or equal to the engine thrust threshold. In other words, the controller 884 turns off the fuel cooling system 302 when the turbine engine is in a cruise mode, a descent mode, or a landing mode (e.g., when the aircraft components need less additional cooling from the fuel cooling system 302). The controller 884 can turn off the fuel cooling system 302 (e.g., control the fuel cooling system fuel pump 306 to prevent the fuel from being pumped out of the fuel tank 304 and into the fuel cooling system fuel line 308) during any engine operating cycle. For example, the controller 884 can turn off the fuel cooling system 302 during at least one of taxiing, takeoff, climb, cruise, descent, or landing of the aircraft.

In step 920, if the engine operating conditions are outside (e.g., are greater than or equal to, or are less than or equal to) the one or more thresholds (step 910: Yes), the controller 884 turns on the fuel cooling system 302. To turn on the fuel cooling system 302, the controller 884 controls the fuel cooling system fuel pump 306 to pump fuel from the fuel tank 304 and into the fuel cooling system fuel line 308. In this way, when the fuel cooling system 302 is turned on, the fuel circulates through the fuel cooling system fuel line 308, absorbs heat through the one or more fuel cooling system heat exchangers 310 to become heated fuel, and the heated fuel is directed back into the fuel tank 304 to be stored in the fuel tank 304. In some examples, the controller 884 turns on the fuel cooling system 302 if the fuel in the fuel tank 304 is below the low temperature threshold T_{L}, if the engine power is greater than or equal to the engine power threshold, if the engine pressure is greater than or equal to the engine pressure threshold, and/or if the engine thrust is greater than or equal to the engine thrust threshold. In other words, the controller 884 turns on the fuel cooling system 302 when the turbine engine is in a takeoff mode and/or in a climb mode (e.g., when the aircraft components need additional cooling from the fuel cooling system 302). For example, during takeoff and climb, the aircraft components require maximum cooling as the temperature of such aircraft components increases during takeoff and during climb. The controller 884 can turn on the fuel cooling system 302 (e.g., controls the fuel cooling system fuel pump 306 to pump the fuel from the fuel tank 304 and into the fuel cooling system fuel line 308) during any engine operating cycle. For example, the controller 884 can turn on the fuel cooling system 302 during at least one of taxiing, takeoff, climb, cruise, descent, or landing of the aircraft. In this way, the controller 884 can turn on the fuel cooling system 302 during any engine operating cycle and the temperature of the fuel in the fuel tank 304 does not exceed the high temperature threshold T_{H}.

Accordingly, the fuel cooling systems disclosed herein utilize the heat capacity of the fuel in the fuel tank to absorb heat for cooling one or more aircraft components. Particularly, the fuel cooling systems herein absorb heat during peak demand conditions (e.g., takeoff and climb) when the aircraft components are hottest. The fuel cooling systems decrease the size, the weight, and the performance requirements of existing thermal management systems for the various subsystems of the aircraft and/or the turbine engine (e.g., CCA, ECS, electronics, motors/generators, cooling burn fuel, etc.). For example, the fuel cooling systems allow the large air-cooled heat exchangers (e.g., about 100 kW) to be replaced with smaller air-cooled heat exchangers (e.g., about 10 kW) and provide the ability to add a liquid-cooled heat exchanger with a lower combined weight compared to larger air-cooled heat exchangers. Therefore, the fuel cooling systems disclosed herein provide for storing heat in the fuel in the fuel tank, using that heated fuel to improve combustion efficiency as compared to lower temperature fuel, and to allow for an overall reduced weight of the thermal management systems, and, thus, an overall reduced weight of the aircraft.

Further aspects are provided by the subject matter of the following clauses.

A fuel system comprises a fuel tank that stores fuel therein, and a fuel cooling system comprising a fuel cooling system fuel line in fluid communication with the fuel tank, one or more fuel cooling system heat exchangers in fluid communication with the fuel cooling system fuel line, and a fuel cooling system fuel pump that pumps the fuel from the fuel tank such that the fuel flows through the fuel cooling system fuel line and into the one or more fuel cooling system heat exchangers to absorb heat from one or more aircraft components to become heated fuel, the heated fuel being returned and stored in the fuel tank.

The fuel system of the preceding clause, further comprising a fuel delivery system comprising a turbine engine having a combustion section, a fuel delivery system fuel line in fluid communication with the fuel tank and the combustion section, and a fuel delivery system fuel pump that pumps the heated fuel from the fuel tank such that the fuel flows through the fuel delivery system fuel line and is delivered to the combustion section.

The fuel system of any preceding clause, the one or more fuel cooling system heat exchangers including an air-to-fuel heat exchanger.

The fuel system of any preceding clause, the one or more fuel cooling system heat exchangers including a component-to-fuel heat exchanger.

The fuel system of any preceding clause, the one or more fuel cooling system heat exchangers including a liquid-to-fuel heat exchanger.

The fuel system of any preceding clause, further comprising a fuel tank heat rejection system that rejects heat from the fuel in the fuel tank.

The fuel system of any preceding clause, further comprising one or more cooling systems including one or more cooling system heat exchangers for cooling one or more cooling system components.

The fuel system of any preceding clause, further comprising a turbine engine, the fuel cooling system turning on or turning off based on engine operating conditions of the turbine engine.

The fuel system of any preceding clause, the fuel cooling system turning on during at least one of taxiing, takeoff, climb, cruise descent, or landing of the aircraft.

The fuel system of any preceding clause, the fuel cooling system turning off during at least one of taxiing, takeoff, climb, cruise, descent, or landing of the aircraft.

The fuel system of any preceding clause, the fuel cooling system turning on during at least one of takeoff or climb of the aircraft.

The fuel system of any preceding clause, the fuel cooling system turning off during at least one of cruise, descent, or landing of the aircraft.

The fuel system of any preceding clause, the one or more fuel cooling system heat exchangers being arranged in series.

The fuel system of any preceding clause, the one or more fuel cooling system heat exchangers being arranged in parallel.

The fuel system of any preceding clause, further comprising a turbine engine having a compressor, and a pre-cooler that receives compressor bleed air from the compressor, the one or more fuel cooling system heat exchangers receiving the compressor bleed air from the pre-cooler such that the fuel absorbs heat from the compressor bleed air as the compressor bleed air passes through the one or more fuel cooling system heat exchangers.

The fuel system of any preceding clause, the one or more cooling systems including the one or more fuel cooling system heat exchangers.

The fuel system of any preceding clause, the one or more fuel cooling system heat exchangers being separate from the one or more cooling systems.

The fuel system of any preceding clause, the one or more cooling systems including one or more air-cooled heat exchangers that cool oil or air with cooling air.

The fuel system of any preceding clause, the fuel delivery system fuel line further including a metering valve and a flowmeter that control the flow rate of the fuel in the fuel delivery system fuel line to the combustion section.

The fuel system of any preceding clause, the one or more cooling systems comprising one or more oil cooling systems for cooling oil.

The fuel system of any preceding clause, the one or more cooling system heat exchangers including one or more cooling system heat exchangers in fluid communication with the fuel delivery system fuel line for receiving fuel in the fuel delivery system fuel line such that the fuel in the fuel delivery system fuel line absorbs heat in the one or more cooling system heat exchangers prior to being delivered to the combustion section.

The fuel system of any preceding clause, the one or more cooling systems comprising an oil cooling system for cooling oil in the turbine engine or in an integrated drive generator (IDG).

The fuel system of any preceding clause, further comprising one or more valves that open to allow the compressor bleed air to flow to the one or more fuel cooling system heat exchangers.

The fuel system of any preceding clause, further comprising one or more temperature sensors for measuring a temperature of the fuel.

The fuel system of any preceding clause, the one or more temperature sensors including a first temperature sensor for measuring a first temperature of the fuel in the fuel tank.

The fuel system of any preceding clause, the one or more temperature sensors including a second temperature sensor for measuring a second temperature of the fuel in the fuel delivery system fuel line.

The fuel system of any preceding clause, the fuel cooling system turning off when the temperature of the fuel increases above a high temperature threshold.

The fuel system of any preceding clause, the fuel cooling system turning on when the temperature of the fuel decreases below a low temperature threshold.

The fuel system of any preceding clause, the fuel cooling system turning on during takeoff and climb of the aircraft.

The fuel system of any preceding clause, the fuel cooling system turning off during cruise of the aircraft.

The fuel system of any preceding clause, the fuel cooling system fuel pump pumping fuel from the fuel tank and into the fuel cooling system fuel line while the fuel cooling system is turned on.

The fuel system of any preceding clause, the fuel cooling system fuel pump being prevented from pumping fuel from the fuel tank and into the fuel cooling system fuel line while the fuel cooling system is turned off.

The fuel system of any preceding clause, the one or more cooling systems being in fluid communication with the fuel tank, the fuel in the fuel tank cooling one or more thermal loads by absorbing heat from the thermal loads in the one or more cooling systems as the fuel flows through the fuel delivery system fuel line to the combustion section.

The fuel system of any preceding clause, the fuel tank heat rejection system comprising a fuel tank compartment in the aircraft, a fuel tank having an exterior surface, the fuel tank storing fuel therein and being located in the fuel tank compartment, and one or more air valves that provide fluid communication to the fuel tank compartment, the one or more air valves opening to operably direct cooling air into the fuel tank compartment through the one or more air valves, the cooling air contacting the exterior surface of the fuel tank such that heat from the fuel is rejected from the fuel tank.

The fuel system of any preceding clause, the fuel tank compartment further comprising one or more air vents that open to operably direct the cooling air to exit the fuel tank compartment through the one or more air vents.

The fuel system of any preceding clause, the fuel tank further including one or more fins that absorb the heat from the fuel tank and reject the heat from the fuel tank.

An aircraft comprises a fuel tank that stores fuel therein, and a fuel cooling system comprising a fuel cooling system fuel line in fluid communication with the fuel tank, one or more fuel cooling system heat exchangers in fluid communication with the fuel cooling system fuel line, and a fuel cooling system fuel pump that pumps the fuel from the fuel tank such that the fuel flows through the fuel cooling system fuel line and into the one or more fuel cooling system heat exchangers to absorb heat from one or more aircraft components, the heated fuel being returned and stored in the fuel tank.

The aircraft of the preceding clause, further comprising a turbine engine having a combustion section, and a fuel delivery system comprising a fuel delivery system fuel line in fluid communication with the fuel tank and the combustion section, and a fuel delivery system fuel pump that pumps the heated fuel from the fuel tank such that the fuel flows through the fuel delivery system fuel line and is delivered to the combustion section.

The aircraft of any preceding clause, the one or more fuel cooling system heat exchangers including an air-to-fuel heat exchanger.

The aircraft of any preceding clause, the one or more fuel cooling system heat exchangers including a component-to-fuel heat exchanger.

The aircraft of any preceding clause, the one or more fuel cooling system heat exchangers including a liquid-to-fuel heat exchanger.

The aircraft of any preceding clause, further comprising a fuel tank heat rejection system that rejects heat from the fuel in the fuel tank.

The aircraft of any preceding clause, further comprising one or more cooling systems including one or more cooling system heat exchangers for cooling one or more cooling system components.

The aircraft of any preceding clause, further comprising a turbine engine, the fuel cooling system turning on or turning off based on engine operating conditions of the turbine engine.

The aircraft of any preceding clause, the fuel cooling system turning on during at least one of taxiing, takeoff, climb, cruise descent, or landing of the aircraft.

The aircraft of any preceding clause, the fuel cooling system turning off during at least one of taxiing, takeoff, climb, cruise, descent, or landing of the aircraft.

The aircraft of any preceding clause, the fuel cooling system turning on during takeoff or climb of the aircraft.

The aircraft of any preceding clause, the fuel cooling system turning off during cruise, descent, or landing of the aircraft.

The aircraft of any preceding clause, the fuel cooling system fuel pump pumping fuel from the fuel tank and into the fuel cooling system fuel line while the fuel cooling system is turned on.

The aircraft of any preceding clause, the fuel cooling system fuel pump being prevented from pumping fuel from the fuel tank and into the fuel cooling system fuel line while the fuel cooling system is turned off.

The aircraft of any preceding clause, the one or more fuel cooling system heat exchangers being arranged in series.

The aircraft of any preceding clause, the one or more fuel cooling system heat exchangers being arranged in parallel.

The aircraft of any preceding clause, further comprising a turbine engine having a compressor, and a pre-cooler that receives compressor bleed air from the compressor, the one or more fuel cooling system heat exchangers receiving the compressor bleed air from the pre-cooler such that the fuel absorbs heat from the compressor bleed air as the compressor bleed air passes through the one or more fuel cooling system heat exchangers.

The aircraft of any preceding clause, the one or more cooling systems including the one or more fuel cooling system heat exchangers.

The aircraft of any preceding clause, the one or more fuel cooling system heat exchangers being separate from the one or more cooling systems.

The aircraft of any preceding clause, the one or more cooling systems including an air-cooled heat exchanger that cools oil or air with cooling air.

The aircraft of any preceding clause, the fuel delivery system fuel line further including a metering valve and a flowmeter that control the flow rate of the fuel in the fuel delivery system fuel line to the combustion section.

The aircraft of any preceding clause, the one or more cooling systems comprising one or more oil cooling systems for cooling oil.

The aircraft of any preceding clause, the one or more cooling system heat exchangers including one or more cooling system heat exchangers in fluid communication with the fuel delivery system fuel line for receiving fuel in the fuel delivery system fuel line such that the fuel in the fuel delivery system fuel line absorbs heat in the one or more cooling system heat exchangers prior to being delivered to the combustion section.

The aircraft of any preceding clause, the one or more cooling systems comprising an oil cooling system for cooling oil in the turbine engine or in an integrated drive generator (IDG).

The fuel system of any preceding clause, the fuel cooling system turning on or turning off based on engine operating conditions of the turbine engine.

The fuel system of any preceding clause, further comprising one or more valves that open to allow the compressor bleed air to flow to the one or more fuel cooling system heat exchangers.

The aircraft of any preceding clause, further comprising one or more temperature sensors for measuring a temperature of the fuel.

The aircraft of any preceding clause, the one or more temperature sensors including a first temperature sensor for measuring a first temperature of the fuel in the fuel tank.

The aircraft of any preceding clause, the one or more temperature sensors including a second temperature sensor for measuring a second temperature of the fuel in the fuel delivery system fuel line.

The aircraft of any preceding clause, the fuel cooling system turning off when the temperature of the fuel increases above a high temperature threshold.

The aircraft of any preceding clause, the fuel cooling system turning on when the temperature of the fuel decreases below a low temperature threshold.

The aircraft of any preceding clause, the fuel cooling system turning on during takeoff and climb of the aircraft.

The aircraft of any preceding clause, the fuel cooling system turning off during cruise of the aircraft.

The aircraft of any preceding clause, the one or more cooling systems being in fluid communication with the fuel tank, the fuel in the fuel tank cooling one or more thermal loads by absorbing heat from the thermal loads in the one or more cooling systems as the fuel flows through the fuel delivery system fuel line to the combustion section.

The aircraft of any preceding clause, the fuel tank heat rejection system comprising a fuel tank compartment in the aircraft, a fuel tank having an exterior surface, the fuel tank storing fuel therein and being located in the fuel tank compartment, and one or more air valves that provide fluid communication to the fuel tank compartment, the one or more air valves opening to operably direct cooling air into the fuel tank compartment through the one or more air valves, the cooling air contacting the exterior surface of the fuel tank such that heat from the fuel is rejected from the fuel tank.

The aircraft of any preceding clause, the fuel tank compartment further comprising one or more air vents that open to operably direct the cooling air to exit the fuel tank compartment through the one or more air vents.

The aircraft of any preceding clause, the fuel tank further including one or more fins that absorb the heat from the fuel tank and reject the heat from the fuel tank.

A method of operating the fuel system of any preceding clause, the method comprising pumping the fuel from the fuel tank with the fuel cooling system fuel pump such that the fuel flows through the fuel cooling system fuel line, directing the fuel into the one or more fuel cooling system heat exchangers such that the fuel absorbs heat from one or more aircraft components to become heated fuel, and returning the heated fuel such that the heated fuel is stored in the fuel tank.

The method of the preceding clause, the fuel system further comprising the fuel delivery system of any preceding clause, the method further comprising pumping the heated fuel from the fuel tank with the fuel delivery system fuel pump such that the fuel flows through the fuel delivery system fuel line, and directing the heated fuel to the combustion section.

The method of any preceding clause, the fuel system being the fuel system of any preceding clause.

The method of any preceding clause, further comprising rejecting heat from the heated fuel in the fuel tank with the fuel tank heat rejection system.

The method of any preceding clause, further comprising directing the compressor bleed air from the pre-cooler through the one or more fuel cooling system heat exchangers, and directing the fuel through the one or more fuel cooling system heat exchangers such that the fuel absorbs heat from the compressor bleed air as the compressor bleed air is directed through the one or more fuel cooling system heat exchangers to become heated fuel.

A method of cooling one or more aircraft components, the method comprising receiving one or more engine operating conditions signals, determining whether the one or more engine operating conditions signals are outside of one or more thresholds, and pumping the fuel from the fuel tank with the fuel cooling system fuel pump if the one or more engine operating conditions signals are outside the one or more thresholds.

The method of the preceding clause, further comprising preventing the fuel from being pumped from the fuel tank and into the fuel cooling system fuel line if the engine operating conditions signals are not outside the one or more thresholds.

The method of any preceding clause, further comprising determining the engine operating conditions based on the engine operating conditions signals.

The method of the preceding clause, the one or more engine operating conditions signals including at least one of engine temperature signals, engine power signals, engine thrust signals, and engine pressure signals.

The method of any preceding clause, further comprising turning on the fuel cooling system during at least one of taxiing, takeoff, climb, cruise descent, or landing of the aircraft.

The method of any preceding clause, further comprising turning off the fuel cooling system during at least one of taxiing, takeoff, climb, cruise, descent, or landing of the aircraft.

The method of any preceding clause, further comprising turning on the fuel cooling system during taxiing, takeoff, or climb of the aircraft.

The method of any preceding clause, further comprising turning off the fuel cooling system during cruise, descent, or landing of the aircraft.

The method of any preceding clause, wherein turning on the fuel cooling system includes pumping fuel from the fuel tank and into the fuel cooling system fuel line.

The method of any preceding clause, wherein turning off the fuel cooling system includes preventing the fuel from being pump from the fuel tank and into the fuel cooling system fuel line.

The method of any preceding clause, the fuel system being the fuel system of any preceding clause.

A fuel cooling control system comprising the fuel system of any preceding clause, and a controller. The controller receiving one or more engine operating conditions signals, determining whether the one or more engine operating condition signals are outside of one or more thresholds, and controlling the fuel cooling system fuel pump to pump fuel from the fuel tank and into the fuel cooling system fuel line if the one or more engine operating condition signals are greater than or equal to, or less than or equal to, the one or more thresholds.

The fuel cooling control system of the preceding clause, further comprising the controller preventing the fuel from being pumped from the fuel tank and into the fuel cooling system fuel line if the one or more engine operating conditions not outside the one or more thresholds.

The fuel cooling control system of any preceding clause, further comprising the controller determining the engine operating conditions based on the engine operating conditions signals.

The fuel cooling control system of the preceding clause, the one or more engine operating conditions signals including at least one of engine temperature signals, engine power signals, engine thrust signals, and engine pressure signals.

The fuel cooling control system of any preceding clause, further comprising the controller turning on the fuel cooling system during at least one of taxiing, takeoff, climb, cruise descent, or landing of the aircraft.

The fuel cooling control system of any preceding clause, further comprising the controller turning off the fuel cooling system during at least one of taxiing, takeoff, climb, cruise, descent, or landing of the aircraft.

The fuel cooling control system of any preceding clause, further comprising the controller turning on the fuel cooling system during taxiing, takeoff, or climb of the aircraft.

The fuel cooling control system of any preceding clause, further comprising the controller turning off the fuel cooling system during cruise, descent, or landing of the aircraft.

The fuel cooling control system of any preceding clause, wherein turning on the fuel cooling system includes pumping fuel from the fuel tank and into the fuel cooling system fuel line.

The fuel cooling control system of any preceding clause, wherein turning off the fuel cooling system includes preventing the fuel from being pump from the fuel tank and into the fuel cooling system fuel line.

The fuel cooling control system of any preceding clause, the fuel system being the fuel system of any preceding clause. Although the foregoing description is directed to the preferred embodiments of the present disclosure, other variations and modifications will be apparent to those skilled in the art and may be made without departing from the spirit or the scope of the disclosure. Moreover, features described in connection with one embodiment of the present disclosure may be used in conjunction with other embodiments, even if not explicitly stated above.

1. A fuel system comprising:
a fuel tank that stores fuel therein; and
a fuel cooling system comprising:
a fuel cooling system fuel line in fluid communication with the fuel tank;
one or more fuel cooling system heat exchangers in fluid communication with the fuel cooling system fuel line; and
a fuel cooling system fuel pump that pumps the fuel from the fuel tank such that the fuel flows through the fuel cooling system fuel line and into the one or more fuel cooling system heat exchangers to absorb heat from one or more aircraft components to become heated fuel, wherein the heated fuel is returned and stored in the fuel tank.

2. The fuel system of claim 1, further comprising a fuel delivery system comprising:
a turbine engine having a combustion section;
a fuel delivery system fuel line in fluid communication with the fuel tank and the combustion section; and
a fuel delivery system fuel pump that pumps the heated fuel from the fuel tank such that the fuel flows through the fuel delivery system fuel line and is delivered to the combustion section.

3. The fuel system of claim 1, wherein the one or more fuel cooling system heat exchangers include an air-to-fuel heat exchanger.

4. The fuel system of claim 1, wherein the one or more fuel cooling system heat exchangers include a component-to-fuel heat exchanger.

5. The fuel system of claim 1, wherein the one or more fuel cooling system heat exchangers include a liquid-to-fuel heat exchanger.

6. The fuel system of claim 1, further comprising a fuel tank heat rejection system that rejects heat from the fuel in the fuel tank.

7. The fuel system of claim 1, further comprising a turbine engine having a compressor, and a pre-cooler that receives compressor bleed air from the compressor, wherein the one or more fuel cooling system heat exchangers receive the compressor bleed air from the pre-cooler such that the fuel absorbs heat from the compressor bleed air as the compressor bleed air passes through the one or more fuel cooling system heat exchangers.

8. The fuel system of claim 1, further comprising one or more cooling systems including one or more cooling system heat exchangers for cooling one or more cooling system components of the one or more cooling systems.

9. The fuel system of claim 8, wherein the one or more cooling systems include the one or more fuel cooling system heat exchangers.

10. The fuel system of claim 8, wherein the one or more cooling systems include an air-cooled heat exchanger that cools oil or air with cooling air.

11. A method of operating a fuel system including a fuel tank that stores fuel therein, and a fuel cooling system comprising a fuel cooling system fuel line in fluid communication with the fuel tank, one or more fuel cooling system heat exchangers in fluid communication with the fuel cooling system fuel line, and a fuel cooling system fuel pump, the method comprising:
pumping the fuel from the fuel tank with the fuel cooling system fuel pump such that the fuel flows through the fuel cooling system fuel line;
directing the fuel into the one or more fuel cooling system heat exchangers such that the fuel absorbs heat from one or more aircraft components to become heated fuel; and
returning the heated fuel to the fuel tank such that the heated fuel is stored in the fuel tank.

12. The method of claim 11, wherein the fuel system comprises a fuel delivery system comprising a turbine engine having a combustion section, a fuel delivery system fuel line in fluid communication with the fuel tank and the combustion section, and a fuel delivery system fuel pump, the method further comprising:
pumping the heated fuel from the fuel tank with the fuel delivery system fuel pump such that the heated fuel flows through the fuel delivery system fuel line; and
directing the heated fuel to the combustion section.

13. The method of claim 11, wherein the fuel system includes a fuel tank heat rejection system, the method further comprising rejecting heat from the heated fuel in the fuel tank with the fuel tank heat rejection system.

14. The method of claim 11, further comprising a turbine engine having a compressor, and a pre-cooler that receives compressor bleed air from the compressor, and the method further comprising:
directing the compressor bleed air from the pre-cooler through the one or more fuel cooling system heat exchangers; and
directing the fuel through the one or more fuel cooling system heat exchangers such that the fuel absorbs heat from the compressor bleed air as the compressor bleed air is directed through the one or more fuel cooling system heat exchangers to become heated fuel.

15. The method of claim 11, further comprising pumping the fuel from the fuel tank with the fuel cooling system fuel pump during at least one of taxiing, takeoff, climb, cruise, descent, or landing of an aircraft.

16. The method of claim 15, further comprising preventing the fuel from being pumped from the fuel tank and into the fuel cooling system fuel line during at least one of taxiing, takeoff, climb, cruise, descent, or landing of the aircraft.

17. The method of claim 11, further comprising pumping the fuel from fuel tank with the fuel cooling system fuel pump during at least one of taxiing, takeoff, or climb of an aircraft.

18. The method of claim 17, further comprising preventing the fuel from being pumped from the fuel tank and into the fuel cooling system fuel line during at least one of cruise, descent, or landing of the aircraft.

19. The method of claim 11, wherein the fuel system includes one or more cooling systems including one or more cooling system heat exchangers, the method further comprising:
cooling one or more cooling system components of the one or more cooling systems with the one or more cooling system heat exchangers.

20. The method of claim 19, wherein the one or more cooling systems include an air-cooled heat exchanger, the method further comprising cooling oil or air with cooling air through the air-cooled heat exchanger.
